(19) United States
(12) Patent Application Publication
(10) Pub. No.: US 2014/0006977 A1
(43) Pub. Date: Jan. 2, 2014

(54) INTEGRATED SOCIAL NETWORK INTERNET OPERATING SYSTEM AND MANAGEMENT INTERFACE

(71) Applicant: Karriem Lateff Adams, Sacramento, CA (US)

(72) Inventor: Karriem Lateff Adams, Sacramento, CA (US)

(21) Appl. No.: 13/854,676

(22) Filed: Apr. 1, 2013

Related U.S. Application Data
(60) Provisional application No. 61/618,629, filed on Mar. 30, 2012.

(51) Int. Cl. H04L 12/58

(52) U.S. Cl. CPC H04L 51/32
USPC 715/758; 715/753

(57) ABSTRACT

A computer-implemented method executed by a server is disclosed. According to the method, a processor links a first social media network and a second social media network in an integrated social media platform. The processor receives a broadcast interaction from a user. The broadcast interaction comprises an interaction between the user and one or more contacts associated with at least one of the first social media network or the second social media network. The processor transmits a notification of the broadcast interaction to at least one of the first social media network and the second social media network. A non-transitory computer-readable storage medium storing the computer-implemented method in the form of executable program instructions embodied therein also is disclosed. A server configured to execute the executable program instructions according to the method also is disclosed.

### CROSS-REFERENCE TO RELATED APPLICATIONS

This application claims the benefit, under 35 U.S.C. §119(e), of U.S. provisional patent application No. 61/618,629, filed Mar. 30, 2012, entitled “Integrated Social Network Internet Operating System and Management Interface,” which is hereby incorporated by reference in its entirety.

### BACKGROUND

Social media websites provide platforms for interactions between users. Current social media platform include platforms, such as, Facebook, Twitter, YouTube, LinkedIn, and Dropbox, to name just a few. Current social media platforms are fragmented, with each social media platform offering one or more features not offered by other social media platforms. For example, a social network such as LinkedIn is directed towards business connections and promoting business interactions, whereas a social network such as Dropbox provides shared storage and management of files through a cloud server. Although social media offers the possibility of multiple interactions between users, the fragmented nature of current social networks limits the value of any social interaction to a single social network or platform.

### SUMMARY

In various embodiments, a computer-implemented method executed by a server is provided. The method comprises linking, by a processor, at least a first social media network and a second social media network in an integrated social media platform. The method further comprises receiving, by the processor, a broadcast interaction from a user. The broadcast interaction comprises an interaction between the user and one or more contacts associated with at least one of the first social media network or the second social media network. The method further comprises transmitting, by the processor, a notification of the broadcast interaction to at least one of the first social media network and the second social media network.

In various embodiments, a non-transitory computer-readable storage medium having executable program instructions embodied therein that when executed by a server perform actions comprising linking, by a processor, at least a first social media network and a second social media network, receiving, by the processor, a broadcast interaction from a user, and transmitting, by the processor, a notification of the broadcast interaction to the first social media network and the second social media network. The broadcast interaction comprises at least one social media activity.

In various embodiments, a computer server is disclosed. The computer server comprises a processor and a non-transitory computer-readable medium storing a computer program executable by the computer processor. The processor is programmed to perform actions comprising linking, by an integrated social media platform, a first social media network and a second social media network, receiving, by the integrated social media platform, a broadcast interaction from a user, wherein the broadcast interaction comprises a social media activity, and transmitting, by the integrated social media platform, a notification of the broadcast interaction to the first social media network and the second social media network.

### FIGURES

The features of the various embodiments are set forth with particularity in the appended claims. The various embodiments, however, both as to organization and methods of operation, together with advantages thereof, may best be understood by reference to the following description, taken in conjunction with the accompanying drawings as follows:

FIG. 1 illustrates one embodiment of an integrated social media platform.

FIG. 2 illustrates one embodiment of a user social activity management interaction.

FIG. 3 illustrates one embodiment of a broadcast interaction.

FIG. 4 illustrates one embodiment of a network process interaction.

FIG. 5 illustrates one embodiment of an administrative interaction.

FIG. 6 illustrates one embodiment of a user registration process.

FIG. 7 illustrates one embodiment of a registration screen.

FIG. 8 illustrates one embodiment of a user login screen.

FIG. 9 illustrates one embodiment of an account management process.

FIG. 10 illustrates one embodiment of a change account screen.

FIG. 11 illustrates one embodiment of a process for linking a YouTube account to the integrated social media platform.

FIG. 12 illustrates one embodiment of a process for linking a Vimeo account to the integrated social media platform.

FIG. 13 illustrates one embodiment of a process for linking a LinkedIn account to the integrated social media platform.

FIG. 14 illustrates one embodiment of a process for linking a Facebook account to the integrated social media platform.

FIG. 15 illustrates one embodiment of a process for linking a Dropbox account to the integrated social media platform.

FIG. 16 illustrates one embodiment of a process for linking a Twitter account to the integrated social media platform.

FIG. 17 illustrates one embodiment of a Facebook interaction process.

FIG. 18 illustrates one embodiment of a Twitter interaction process.

FIG. 19 illustrates one embodiment of a Dropbox interaction process.

FIG. 20 illustrates one embodiment of a dashboard theme management screen.

FIG. 21 illustrates one embodiment of a social media identity page generation process.

FIGS. 22 and 23 illustrate various embodiments of social media identity pages.

FIG. 24 illustrates one embodiment of a social media interaction between the user and the integrated social media platform.

FIG. 25 illustrates one embodiment of a broadcast interaction process.

FIGS. 26-31 illustrate various embodiments of a dashboard broadcast interaction screen.

FIG. 32 illustrates one embodiment of a dashboard video chat screen.

FIG. 33 illustrates one embodiment of a dashboard text chat screen.

FIG. 34 illustrates one embodiment of a dashboard conference set up screen.

FIGS. 35-37 illustrate various embodiments of a dashboard conference screen.

FIG. 38 illustrates one embodiment of a conference broadcast interaction by the user using the integrated social media platform.

FIG. 39 illustrates one embodiment of a webcast interaction by the user using the integrated social media platform.

FIG. 40 illustrates one embodiment of an application selection process.

FIG. 41 illustrates one embodiment of a dashboard games screen.

FIG. 42 illustrates one embodiment of a dashboard application purchase screen.

FIG. 43 illustrates one embodiment of a dashboard payment completion screen.

FIG. 44 illustrates one embodiment of a dashboard gadget screen.

FIG. 45 illustrates one embodiment of an online advertising interaction using the integrated social media platform.

FIG. 46 illustrates one embodiment of a social media search interaction using the integrated social media platform.

FIG. 47 illustrates one embodiment of a dashboard search results page.

FIG. 48 illustrates one embodiment of a visitors dashboard analytical screen configured by country.

FIG. 49 illustrates one embodiment of a visitors dashboard analytics screen configured by age.

FIG. 50 illustrates one embodiment of a visitors dashboard analytics screen configured by country within a specific age range.

FIG. 51 illustrates one embodiment of a demographic dashboard analytics screen.

FIG. 52 illustrates one embodiment of an integrated social media platform illustrated as plurality of stacks.

FIG. 53 illustrates one embodiment of an integration process executed by the integrated social media platform.

FIG. 54 illustrates one embodiment of an automation flow process.

FIG. 55 illustrates one embodiment of a social media identity page.

FIG. 56 illustrates one embodiment of a computing device which can be used in one embodiment of the system and method for providing an integrated social media platform.

FIG. 57 illustrates one embodiment of a computer-implemented method that can be executed by computing device and more specifically by the one or more processor circuits or processing units of a computing device.

### DESCRIPTION

Reference will now be made in detail to several embodiments, including embodiments showing example implementations of systems and methods for providing an integrated social media platform. Wherever practicable similar or like reference numbers may be used in the figures and may indicate similar or like functionality. The figures depict example embodiments of the disclosed systems and/or methods of use for purposes of illustration only. One skilled in the art will readily recognize from the following description that alternative example embodiments of the structures and methods illustrated herein may be employed without departing from the principles described herein.

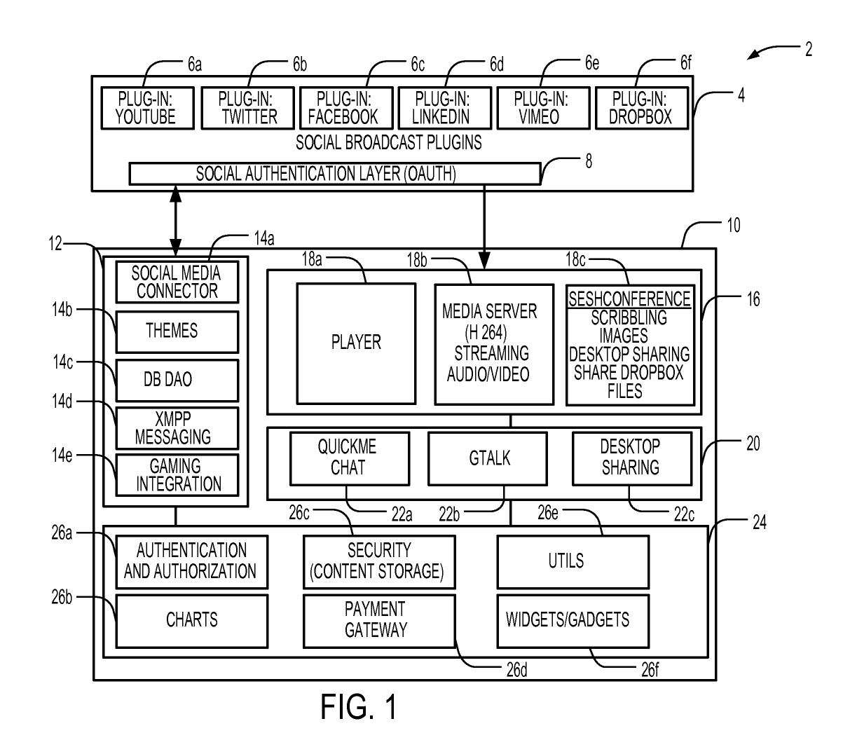

FIG. 1 illustrates one embodiment of an integrated social media platform 2. The integrated social media platform may comprise, for example, an internet operating system, such as for example, an operating system running on a web-connected server computer. In some embodiments, the integrated social media platform may comprise an ecommerce TV portal platform for mass social advertising via automated e-commerce tools configured to generate a social interactive media portal via an internet or other web connection. The integrated social media platform 2 may comprise an open-integrated software stack of modules and plug-ins configured to automate a core set of features within each module. The open-integrated software stack of modules may allow users to establish online social media and/or TV services, for example, to create interactive video content. In some embodiments, the integrated social media platform may provide an automated structure for the operation and management of web-based internal and/or external social-service, social-communication, and social activity providers.

In some embodiments, the integrated social media platform 2 may generate an environment on a user device, such as, for example, a desktop or mobile device through a web browser or other network application. For example, in some embodiments, an online suite of applications may generate a unique user interface, such as, for example, a user dashboard, on a user device. The user interface may be referred to as a web operating system or internet operating system (IOS). In some embodiments, the integrated social media platform 2 may comprise an interactive web portal. The interactive web portal may provide one or more interactive social media portals to one or more users. The interactive social media portals may allow a user to engage in automated social-portal broadcast interactions. The integrated social media platform 2 may comprise an integrated management interface for all social service, social communication, social storage, and or social archive applications.

In some embodiments, an integrated social media platform 2 may comprise one or more modules and one or more plug-ins arranged in an open-integrated software stack. The integrated social media platform 2 may comprise, for example, a social broadcast plug-in module 4. The social broadcast plug-in module 4 may comprise a plurality of social media plug-ins 6a-6f configured to provide integration of one or more social networking platforms. The social broadcast plug-in module 4 may comprise, for example, a YouTube plug-in 6a, a Twitter plug-in 6b, a Facebook plug-in 6c, a LinkedIn plug-in 6d, a Vimeo plug-in 6e, and a Dropbox plug-in 6f. Other social media plug-ins may be added to provide access to additional social networking platforms. The open-integrated software stack may allow users to generate or customize social media plug-ins for any social networking platform. For example, a user may generate a social media plug-in for a social media network not provided by the integrated social media platform 2 or may generate a plug-in for providing additional or different functionality for an integrated social media network. The social broadcast plug-ins module 4 may comprise a social authentication layer 8 to provide authentication between the integrated social media platform 2 and the one or more social networks.

In some embodiments, the integrated social media platform 2 may comprise a portal subscriber module 10. The portal subscriber module 10 may provide user functionality through one or more modules. For example, the portal subscriber module 10 may comprise a base module 12, a video and conferencing module 16, a chat module 20, and an add-on module 24. The base module 12 may provide basic functionality to the integrated social media platform 2, for example, by providing a social media connector 14a for connecting one or more social networking and/or social media sites (for example, through the social broadcast plug-in module 4), a themes plug-in 14b for allowing a user to customize the integrated social media platform with a user-selected and/or user-defined theme, a database access object plug-in 14c configured to provide access to one or more databases and/or other data stores, an Extensible Messaging and Presence Protocol (XMPP) messaging plug-in 14d for providing near real-time chat and presence information, and a gaming integration plug-in 14e for integrating one or more games, such as, for example, platform-specific and/or web-based games, with the integrated social media platform 2.

In some embodiments, the integrated social media platform 2 may comprise a video and conferencing module 16. The video and conferencing module 16 may provide video and conferencing functionality to the integrated social media platform 2. The video and conferencing module 16 may comprise, for example, a player plug-in 18a configured to provide online TV functionality, a media server plug-in 18b configured to provide streaming audio and/or video functionality, and a SeshConference plug-in 18c configured to provide conferencing capabilities, such as, for example, video conferencing, scribbling, image sharing, desktop sharing, and/or Dropbox file sharing. A chat module 20 may be configured to provide one or more chat programs through the integrated social media platform 2, such as, for example, through an in embedded chat plug-in 22a, a GTALK (or Google Talk) plug-in 22b, and a desktop sharing plug-in 22c. The chat module 20 and the video and conferencing module 16 may be configured to provide seamless video, audio, desktop sharing, and/or chat conferencing.

In some embodiments, the integrated social media platform 2 may comprise a add-on module 24. The add-on module 24 may be configured to provide additional functionality to the integrated social media platform 2 through one or more functionality plug-ins 26a-26f. For example, the add-on module 24 may comprise an authentication and authorization plug-in 26a configured to provide authentication of information sent and received from the integrated social media platform 2 and may provide authorization to change one or more connected services, such as, for example, authorizing a change to a user's social network profile based on a change in the integrated social media platform 2. A charts plug-in 26b may provide functionality for generating one or more charts based on data received by the integrated social media platform 2 and/or data generated independently by the integrated social media platform 2. A security plug-in 26c may provide security for one or more functions of the integrated social media platform 2. For example, the security plug-in 26c may provide security for content storage by establishing a secure connection and/or encrypting data. The security plug-in 26c may provide transaction security for one or more transactions initiated by within the integrated social media platform 2 and may provide security for streaming content, such as, for example, by establishing secure connections and encrypting data prior to transmission.

In some embodiments, the add-on module 24 may comprise a payment gateway plug-in 26d. The payment gateway plug-in 26d may provide payment functionality for payment of one or more transactions initiated within the integrated social media platform 2. The payment gateway plug-in 26d may allow a user, for example, to pay for one or more transactions with a credit card, through an online payment system, or through one or more payment systems established by a social network. A UTILS plug-in 26e may provide one or more utilities to the integrated social media platform 2, such as, for example, administrative utilities or usage tracking. The add-on module 24 may comprise a widgets/gadgets plug-in 26f. The widgets/gadgets plug-in 26f may enable one or more widgets and/or gadgets to be added to the integrated social media platform 2. For example, in some embodiments, the integrated social media platform 2 may be in communication with an app store that may provide access to one or more widgets, such as, for example, a weather widget, a time widget, or a calendar widget, to name just a few. Although the integrated social media platform 2 has been discussed with reference to specific modules and plug-ins, those skilled in the art will recognize that additional plug-ins and/or modules may be added to the integrated social media platform 2 to add additional functionality.

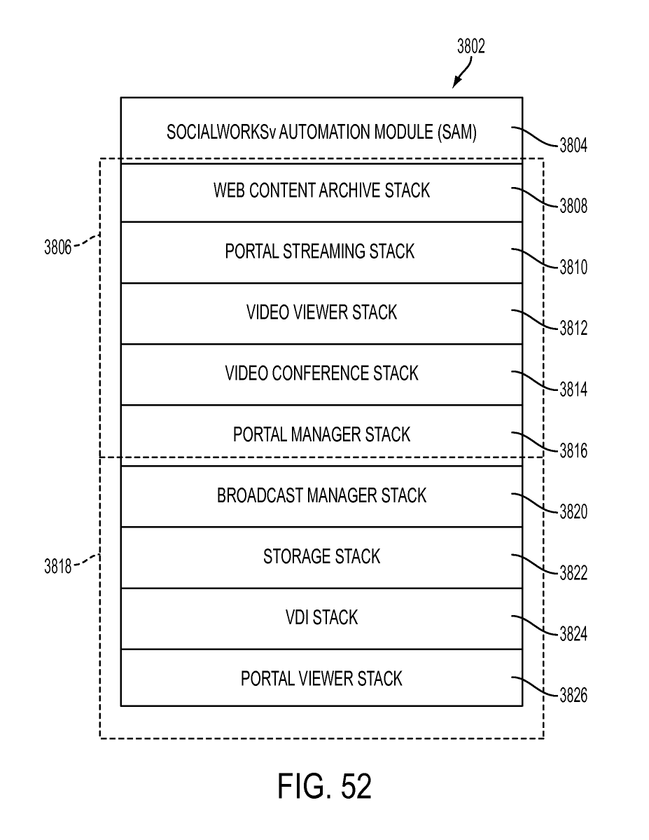

FIG. 52 illustrates one embodiment of an integrated social media platform 3802 illustrated as plurality of stacks. In some embodiments, the integrated social media platform 3802 may comprise a core module 3804. The core module 3804 may operate one or more refined general policies and rules that may serve as input the self operation of the integrated social media platform 3802. In some embodiments, the integrated social media platform 3802 may comprise a portal subscriber module 3806. The subscriber module 3806 may comprise a web content archive stack 3808 configured to automate web page content extraction and archive automation. The web content archive stack 3808 may automate extraction and archiving of, for example, videos, audio files, and documents. The portal subscriber module 3806 may comprise a portal streaming stack 3810. The portal streaming stack 3810 may be configured to provide cinematic video processing and/or streaming. The portal streaming stack 3810 may provide automation of editing any content stored within the web content archive stack 3808 and/or stored in any other social storage site, such as, for example, Dropbox. The portal streaming stack 3810 may provide one or more editing tools for editing content.

In some embodiments, the portal subscriber module 3806 may comprise a video viewer stack 3812. The video viewer stack 3812 may be configured to provide automation with online social media providers, such as, for example, YouTube. A video conferencing stack 3814 may provide automation of online social conferencing providers, such as, for example, FUZE. A portal manager stack 3816 may be configured to provide dashboard management of all social networks, communications, and/or online applications.

The integrated social media platform 3802 may comprise a social subscriber module 3818. The social subscriber module may comprise broadcast manager stack 3820 configured to provide dashboard management with interactive social broadcasting tools. A storage stack 3822 may be configured to provide automation of online social storage providers, such as, for example, Dropbox. A portal viewer 3826 may provide a social subscriber portal viewer, such as, for example, by generating a social media identity page for one or more users. In some embodiments, a VDI stack 3824 may provide virtual desktop management.

In some embodiments, the integrated social media platform 3802 is configured such that human operation is not required to control the integrated social media platform 3802 modules and plug-ins directly. The integrated social media platform 3802 may operate one or more refined general policies and rules that serve as input to the self operation of the integrated social media platform 3802. The integrated social media platform may provide automated structure to the operation of one or more web-based internal ad external social service, social communication, social storage, and/or social archive applications/networks managed through the integrated social media network.

In some embodiments, the integrated social media platform 2 may comprise a representational state transfer (REST or RESTful) application programming interface (API). The RESTful API may provide functionality to map one or more social media or platform APIS while also providing support for data protection and enhanced security. For example, the RESTful API may be configured to provide automated provisioning of resources required to delivery any service process instance requested over the RESTful API and/or provide automated continuity of service in the event of any dependent resource failure. The RESTful API may comprise one or more unique quality of service (QOS) features and/or mechanisms that guarantee all resource failures are transported to one or more hosted applications and any constraints of the application required to maintain application delivery without loss of performance are maintained. The RESTful API may provide multi-tenancy across all resources within the integrated social media platform 3802. The RESTful API may be configured to automatically monitor and control resources to ensure optimal functioning of the integrated social media platform 2 and/or associated infrastructure in support of workloads placed on the integrated social media platform 3802.

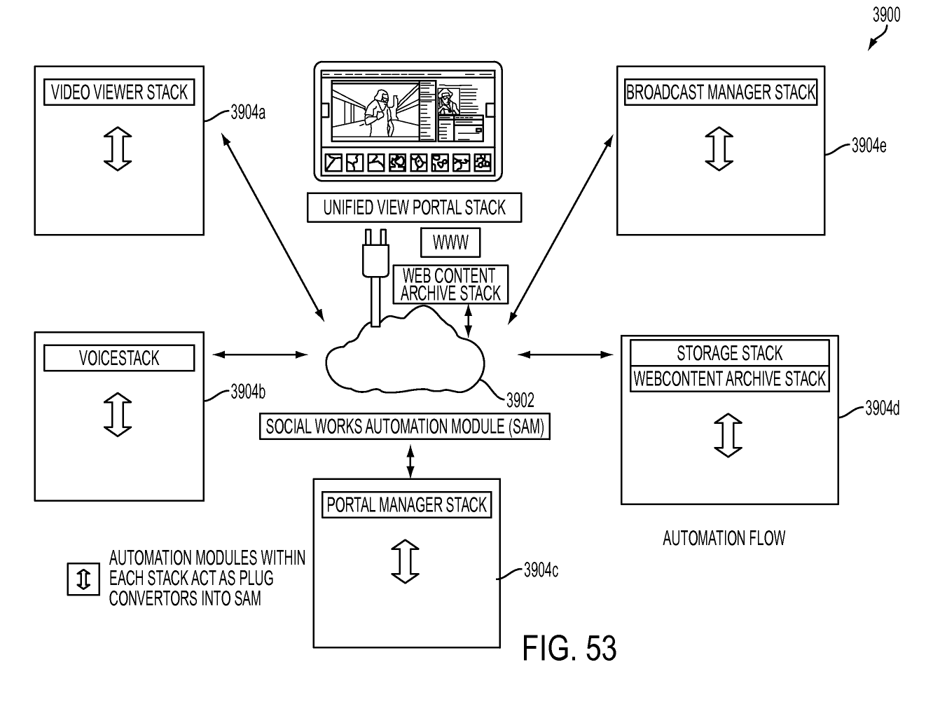

FIG. 53 illustrates one embodiment of an integration process 3900 executed by the integrated social media platform 2. In one embodiment, network automation modules may be built for each social communication category currently available to integrate with the integrated social media platform 3802. For example, in one embodiment, the integrated social media platform 3802 may generate a video viewer stack 3804 for integrating one or more video-based social networks, such as, for example, YouTube or Vimeo, a voice stack 3806 for integrating with one or more voice and/or video chat social networks, such as, for example Google Talk and/or Skype, a portal manager stack 3808 for integrating with one or more content-based social networks, such as, for example, Facebook or Twitter, a storage stack 3810, or a web content archive stack) for integrating with one or more storage-based social networks, such as, for example, Dropbox, and/or a broadcast manager stack 3812 for integrating with one or more conference-based social communication platforms, such as, for example, FUZE and/or WebEx. The integrated social media platform 3902 may integrated and aggregate content from each of the connected stacks and may generate a single unified view, for example, through a unified view portal stack 3814. The unified view portal stack 3814 may generate a unified social media page, for example, a social media identity page, comprising the unified social media data from the one or more integrated social communication services.

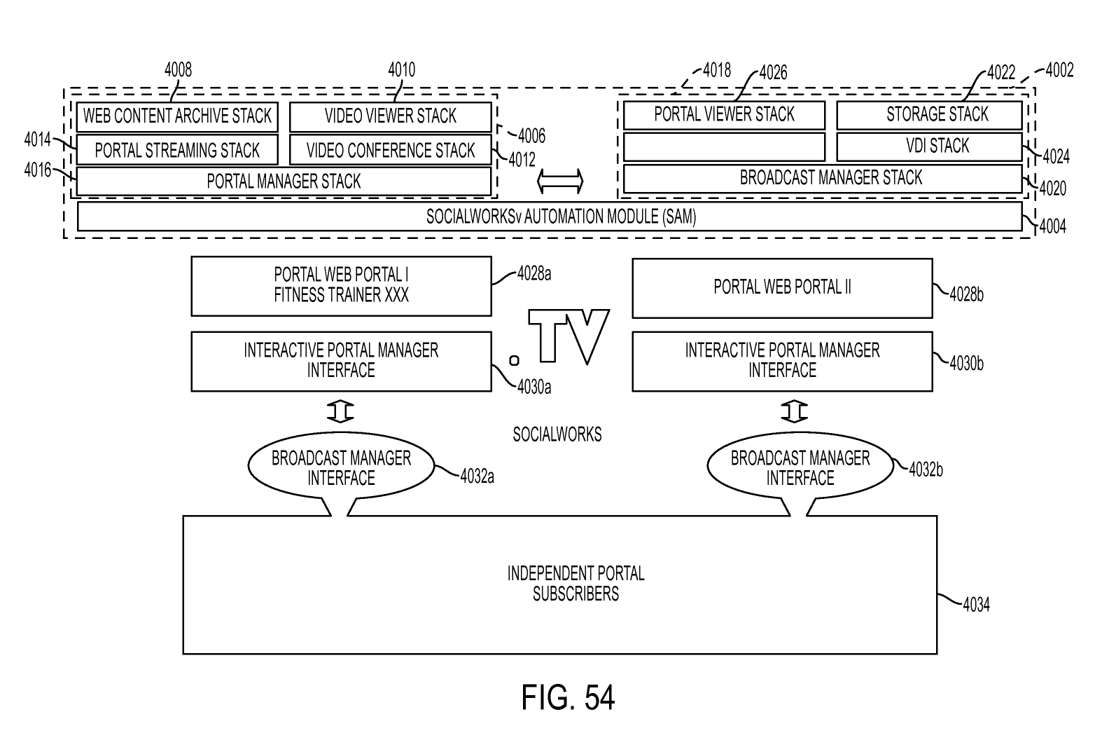

FIG. 54 illustrates one embodiment of an automation flow process 4000. An integrated social media platform 4002 may provide one or more automated controls for integrating and aggregating social media content across multiple platforms. As discussed above, the integrated social media platform 4002 may comprise one or more modules, plug-ins, and/or stacks to automate one or more processes of the integrated social media platform 4002. The integrated social media platform 4002 may comprise, for example, a core module 4004, a portal subscriber module 4006, and a social subscriber module 4018. The portal subscriber module 4006 may comprise, for example, a web content archive stack 4008, a video viewer stack 4010, a video conference stack 4012, a portal streaming stack 4014, and/or a portal manager stack 4016. The social subscriber module 4018 may comprise, for example, a portal viewer stack 4026, a storage stack 4022, a VDI stack 4024, and/or a broadcast manager stack 4020. The integrated social media platform 4002 may provide a web portal to one or more users. For example, a first web portal 4028a may be provided to a first user and a second web portal 4028b may be provided to a second user. The first and second users may interact with respective interactive portal managers 4030a, 4030b to manage one or more aspects of the associated web portal 4028a, 4028b, for example, by linking one or more social communication networks, removing one or more social networks, posting content, and/or managing one or more settings of the integrated social media platform 4002.

In some embodiments, a broadcast manager 4032a, 4032b may manage the interactions between a user's web portal 4028a, 4028b and one or more independent portal subscribers 4034. An independent portal subscriber 4034 may comprise, for example, a socially verified user that has downloaded one or more applications associated with the integrated social media platform 4002. In some embodiments, the application may comprise the interactive portal manager interface 4030a, 4030b. In some embodiments, an independent portal subscriber may be able to interact with one or more portals after the independent portal subscriber as been socially connected with the portal manager. For example, social connections may comprise a Facebook “Like”, a Twitter “Follow”, a LinkedIn “connect”, or any other social connection. In some embodiments, an independent portal subscriber may be able to purchase ad space within other portals and/or be a guest on another's portal to obtain new social friends and/or viewers

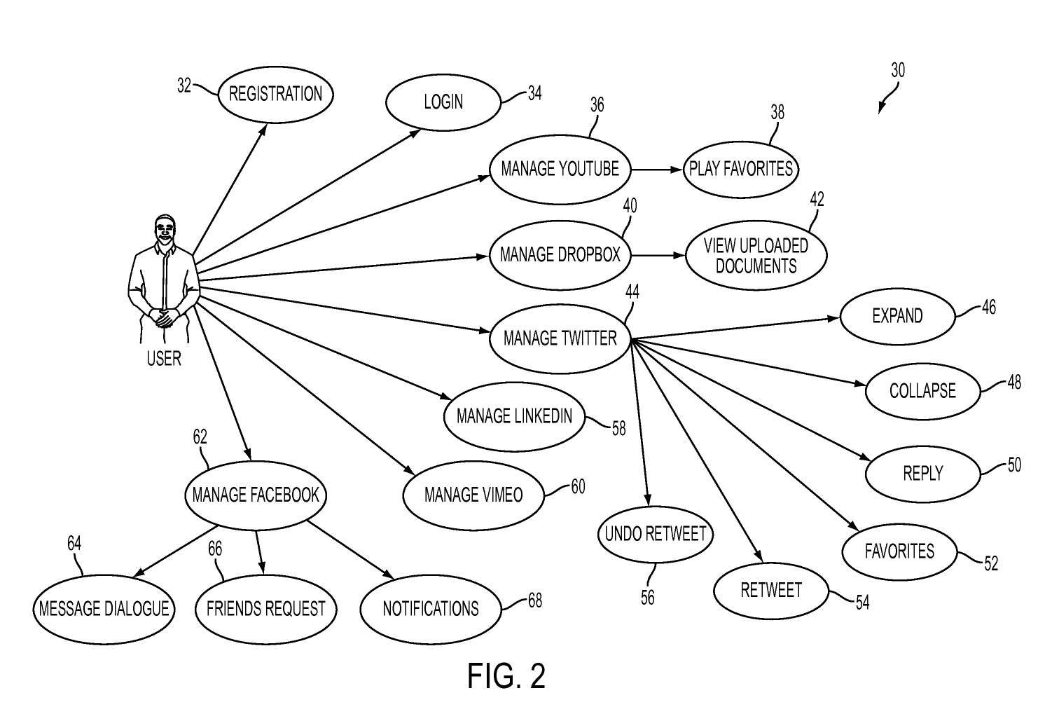

FIG. 2 illustrates one embodiment of a user social activity management interaction 30. A user 31 may initiate one or more interactions with the integrated social media platform 2, for example, registering 32 with the integrated social media platform, logging-in 34 to the integrated social media platform, and/or managing one or more social networks. For example, in one embodiment, a user 31 may register 32 with the integrated social media platform 2. During registration, the user 31 may provide user information, such as, for example, a username and password to the integrated social media platform 2. The integrated social media platform 2 may connect to one or more social networks. The user 31 may login 34 to the integrated social media platform 2, for example, using the username and password established during registration. Once the user 31 has logged-in to the integrated social media platform 2, the integrated social media platform 2 may manage the one or more social networks connected to the integrated social media platform. For example, in one embodiment, the integrated social media platform 2 may manage 36 a YouTube account. The user 31, through the integrated social media platform 2, may manage 36 their YouTube account to perform one or more actions, such as, for example, playing 38 favorite videos. A Dropbox account may be connected to the integrated social media platform 2. The integrated social media platform 2 may manage 40 the connected Dropbox account to display uploaded documents 42 stored in the Dropbox account. In some embodiments, the integrated social media platform 2 may be configured to share one or more documents stored in the Dropbox account.

In some embodiments, a Twitter account may be integrated with the integrated social media platform 2. The integrated social media platform 2 may provide one or more options for managing 44 the Twitter account. For example, the integrated social media platform 2 may manage 44 the Twitter account by expanding 46 and/or collapsing 48 a list of tweets, generating 50 a reply to a tweet, adding 52 a tweet to the user's favorites, retweeting 54 a specific tweet, and/or undoing 56 a retweet. The integrated social media platform 2 may provide seamless integration of the Twitter account such that a user of the integrated social media platform 2 may perform any function for the Twitter account through the integrated social media platform 2.

In some embodiments, the integrated social media platform 2 may be integrated with a LinkedIn profile. The integrated social media platform 2 may manage 58 the LinkedIn profile to update, view, or respond to messages. In some embodiments, the integrated social media platform 2 may be integrated with a Vimeo profile. The integrated social media platform 2 may manage 60 the Vimeo profile to play one or more Vimeo videos. In some embodiments, the integrated social media platform 2 may be integrated with a Facebook profile and may allow management 62 of the Facebook profile seamlessly through the integrated social media platform 2. For example, the integrated social media platform 2 may manage 62 a Facebook account to allow a user to view and/or respond 64 to one or more message dialogues (for example, by integrating a Facebook chat session into the integrated social media platform 2), respond 66 to a friend request, and/or displaying 68 notifications.

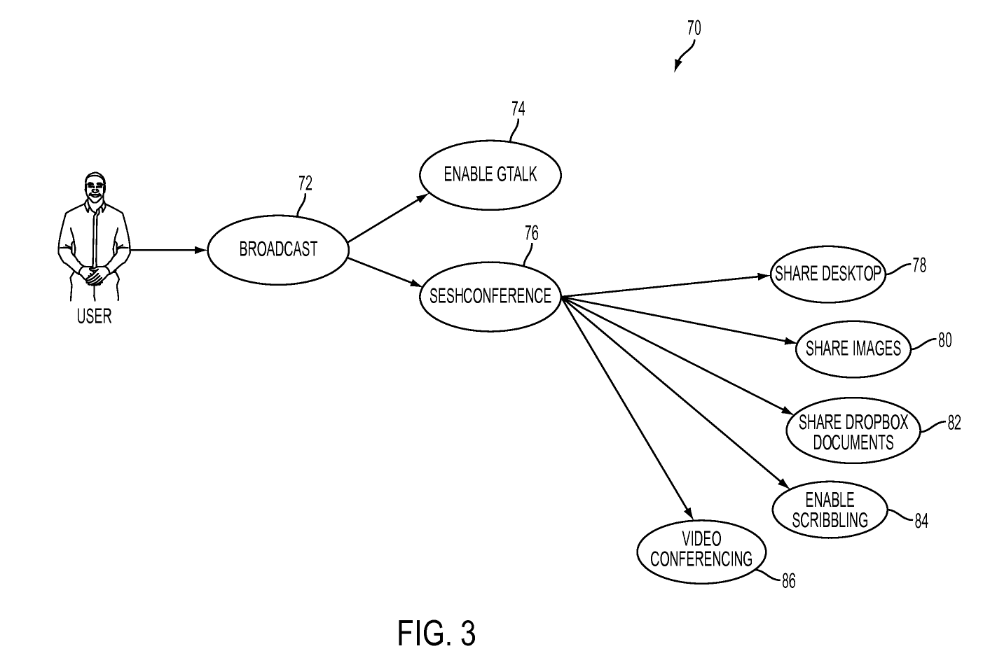

FIG. 3 illustrates one embodiment of a broadcast interaction 70 executed by the integrated social media platform 2. A broadcast interaction 70 may comprise, for example, a social media interaction, such as, for example, posting content, initiating a chat session, initiating a conference session, initiating a webcast, updating user information, or otherwise interacting with one or more social media networks and/or social media contacts. A user 31 may interact with the integrated social media platform 2 to initiate one or more broadcast functions 72, such as, for example, a Google Talk function and/or a conferencing function. The integrated social media platform 2 may enable 74 a Google Talk plug-in to interact with one or more contacts via an integrated Google Talk account. The integrated social media platform 2 may provide integration of Google Talk, for example, to a user dashboard. In some embodiments, the integrated social media platform 2 may be configured to enable 76 one or more conference functions. The one or more conference functions may be provided by a plug-in, for example, the SeshConference plug-in 18c. The integrated social media platform 2 may be configured to share 78 the user's desktop with one or more conference participants, share 80 images with one or more conference participants, share 82 Dropbox documents, enable 84 scribbling, and/or provide 86 video conferencing between one or more conference participants.

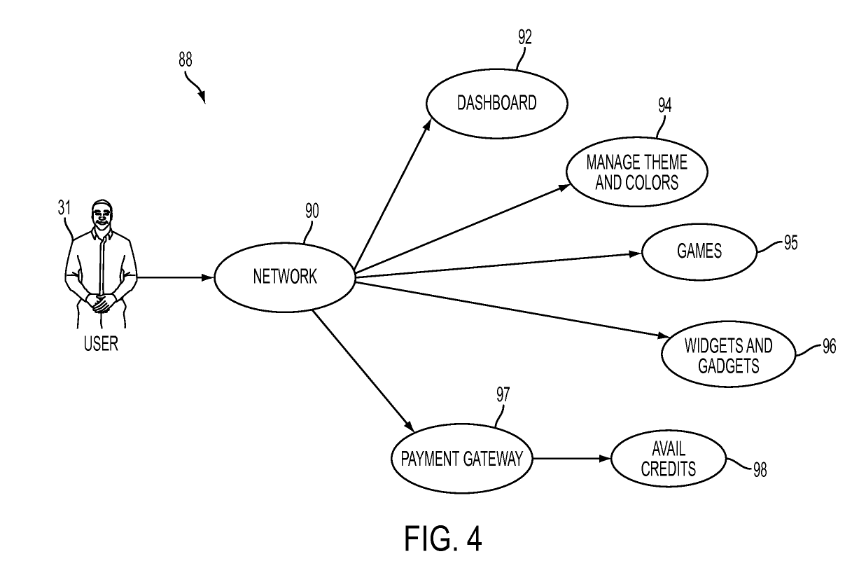

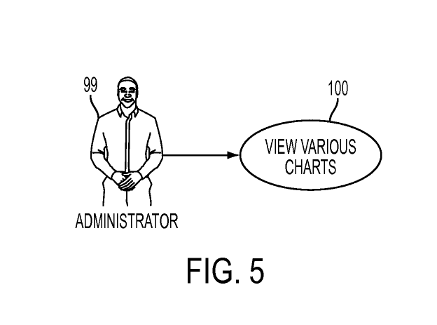

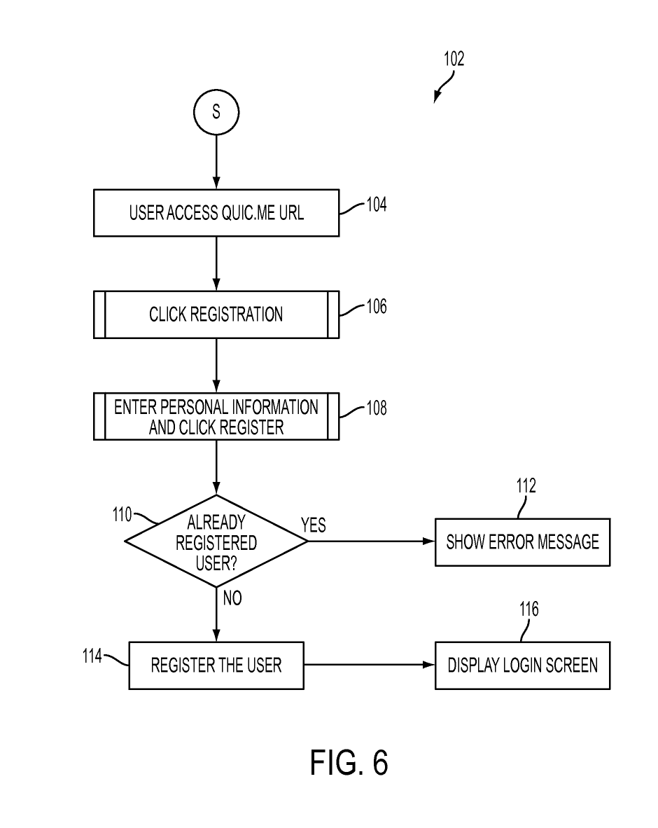

FIG. 4 illustrates one embodiment of a network functionality interaction 88 executed by the user using the integrated social media platform 2. A user 31 may interact with the integrated social media platform 2 to initiate 90 one or more network functions. For example, in one embodiment, the user 31 may interact with the integrated social media platform 2 to select 92 a dashboard comprising one or more additional features of the integrated social media platform 2. The dashboard may be configured to display one or more pages to enable a user to manage an account for the integrated social media platform 2, manage one more listed social networks, and/or initiate one or more broadcast interactions. The integrated social media platform 2 dashboard may be configured to manage 94 themes and/or colors of the integrated social media platform 2 to customize one or more displays, such as, for example, a dashboard and/or a social media identity page discussed in more detail below. The integrated social media platform 2 may execute 95 one or more games and/or may execute 96 one or more widgets/gadgets. For example, in some embodiments, the integrated social media platform 2 may comprise an app store configured to allow a user 31 to add one or more games, widgets, and/or gadgets to the integrated social media platform 2. The integrated social media platform 2 may implement a payment gateway to provide payment for one or more transactions performed through the integrated social media platform 2. The integrated social media platform 2 may be configured to check 98 available credits and/or balances for one or more user accounts linked to the integrated social media platform 2, for example, the balances of one or more online payment systems. FIG. 5 illustrates one embodiment of an administrative interaction between an administrator 99 and the integrated social media platform 2. The integrated social media platform 2 may provide 100 one or more charts associated with analytical data related to the integrated social media platform 2 and/or one or more connected platforms, such as, for example, connected social media networks, to an administrator 99. An administrator may comprise any user managing an account, such as, for example, linking one or more social media accounts, posting content, and/or tracking page analytics.

In some embodiments, the integrated social media platform 2 may be configured to register 32 one or more users. FIG. illustrates one embodiment of a registration process 102. The registration process 102 may comprise a user accessing 104 the integrated social media platform 2 through an internet or other network connection. The integrated social media platform 2 may comprise a uniform resource locator (URL) to facilitate easy access of the integrated social media platform 2. For example, a quic.me URL may be associated with the integrated social media platform 2. A user may interact 106 with a registration link displayed by the integrated social media platform 2. The integrated social media platform 2 may display a registration screen for collecting 108 user personal information for registration. The integrated social media platform 2 may compare 110 the collected user personal information with user information stored by the integrated social media platform 2 to determine if the user has already registered. If the user personal information matches information stored by the integrated social media platform 2, the integrated social media platform 2 may display 112 an error message indicating the user is already registered. If the collected user personal information does not match information stored by the integrated social media platform 2, the integrated social media platform 2 may register 114 the user using the collected personal information. After registering 114 the user, the integrated social media platform 2 may display 116 a login screen to allow the user to login to the integrated social media platform 2.

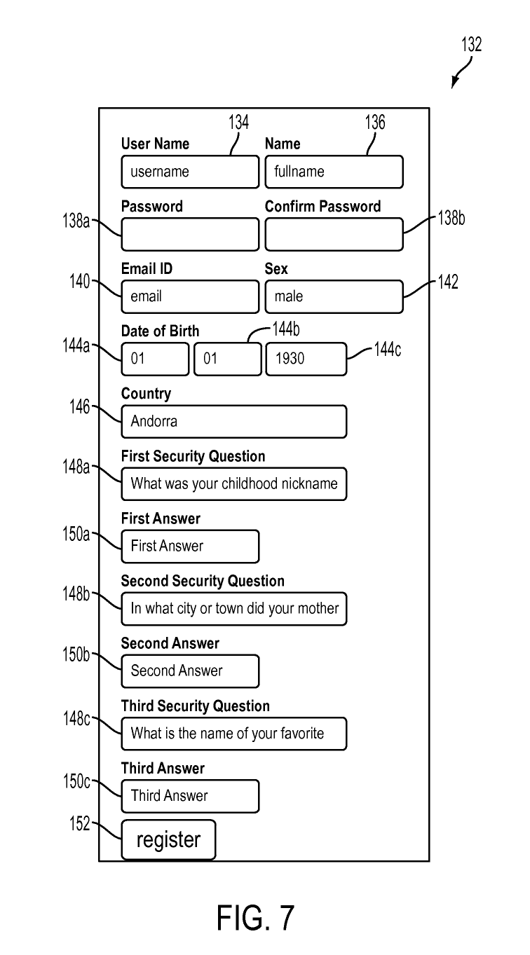

FIG. 7 illustrates one embodiment of a registration screen 132. The registration screen 132 may be configured to collect data from a user 31 for registering the user 31 with the integrated social media platform 2. For example, the registration screen 132 may comprise a username 134 field configured to receive a user's selected username. A real-name field 136 may be configured to receive the user's real name. The registration screen 132 may comprise a password box 138a and a password confirmation box 138b for receiving a user selected password. The integrated social media platform 2 may notify the user if the passwords in the password box 138 and the password confirmation box 138b do not match. The registration screen 132 may require entry of a valid e-mail address 140 for the user. The registration screen 132 may collect information about the user's sex 142, date of birth 144a-144c and country of residency 146. The country of residency 146 may be entered through a dynamically loading list of country names that updates based on the entries of the user. The integrated social media platform 2 may require one or more security question 148a-148c and one or more associated security question answers 150a-150c. The security questions 148a-148c and the security question answers 150a-150c may be used, for example, for password recovery if a user 31 forgets the user's password. In some embodiments, the user 31 may select a security question 148a-148c from a dynamically loading list of questions. The dynamically loading list of questions may be updated based on the user's previous security question selections. A register button 152 may provide the entered registration information to the integrated social media platform 2 for registration of the user.

In some embodiments, one or more of the fields of the registration screen 132 may comprise a mandatory field. A mandatory field may require an entry and may provide an error to a user 31 if a mandatory field has a null value, for example, if a user 31 has failed to enter information into a mandatory field. The integrated social media platform 2 may indicate which mandatory field generated the error and may prompt a user to complete the mandatory field. The integrated social media platform 2 may generate an error if a mandatory field contains non-conforming information. For example, if a user enters a date of birth outside of an accepted range, such as, for example, entering 13 for the month 150a, the integrated social media platform 2 may generate an error and indicate that the value entered in a mandatory field is non-conforming. In some embodiments, the integrated social media platform 2 may perform an e-mail validation of the information entered into the registration screen 132. For example, the integrated social media platform may generate an e-mail to the entered e-mail address 140 requiring the user to interact with a link within the e-mail and validate that the user 31 is associated with the entered e-mail address 140. In some embodiments, the integrated social media platform 2 may validate the date for the date of birth 150a-150c, for example, ensuring that the date is within a specific range.

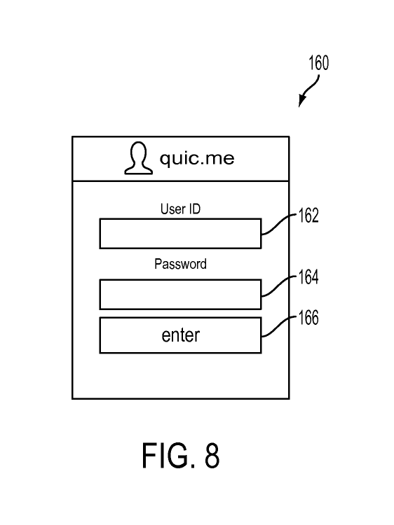

FIG. 8 illustrates one embodiment of a login screen 160 that may be displayed by the integrated social media platform 2. The login screen 160 may allow a user to login into a user account on the integrated social media platform 2. The login screen 160 may comprise a username, or user ID, field 162 and a password field 164. After entering a username and password, the user may submit the information to the integrated social media platform 2 using a button 166.

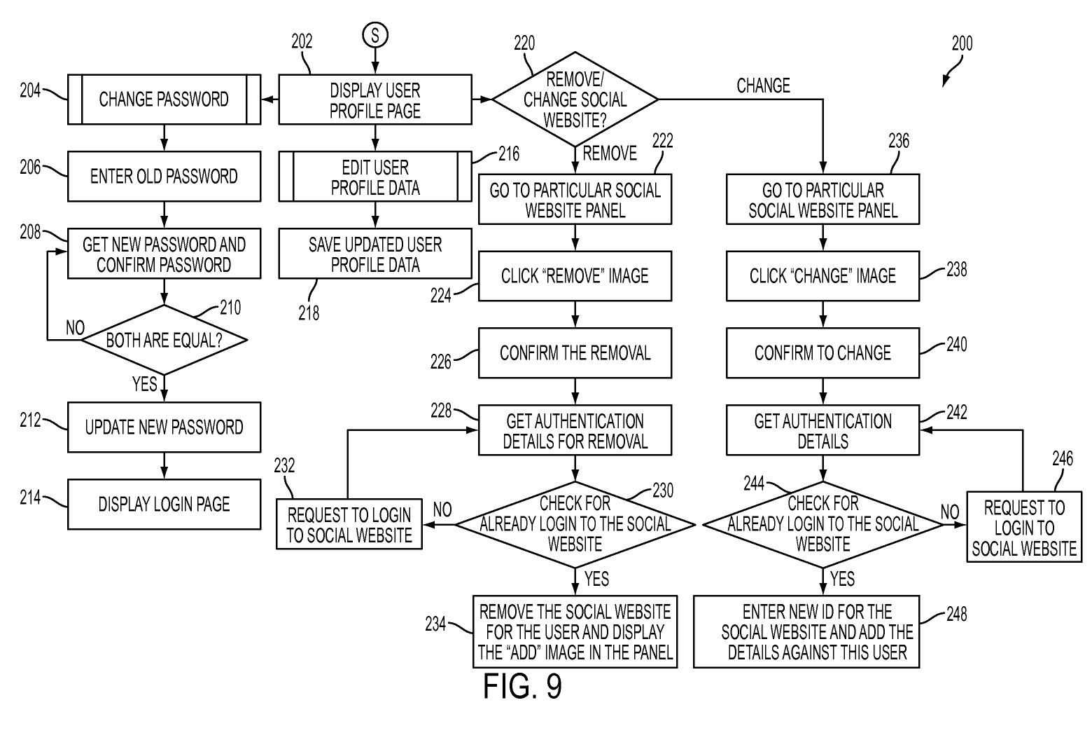

FIG. 9 illustrates one embodiment of an account management process 200. The integrated social media platform 2 may provide a user dashboard configured to allow a user to manage a user account, for example, by changing user information, adding social networks, editing social network information, or removing social networks from the integrated social media platform 2. When a user logs into the integrated social media platform 2, the integrated social media platform 2 may display 202 a user profile page. In some embodiments, the user profile page may comprise a user's social media identity page (discussed in more detail below). In some embodiments, the integrated social media platform 2 may display 202 a user profile page comprising a configuration page. For example, a configuration page may be displayed the first time a user logs into the integrated social media platform 2. In some embodiments, the user profile page may comprise a user dashboard page. A user may initiate 204 a change of the user's password. The integrated social media platform 2 may receive 206 the user's current password, for example, by displaying a password box to the user. The integrated social media platform 2 may receive 208 a new password from the user. In some embodiments, the integrated social media platform 2 may receive 208 a confirmation copy of the password. For example, the integrated social media platform 2 may require a user to enter the new password twice to ensure the password is properly entered. The integrated social media platform 2 may verify 210 that the new password and the confirmation password are the same. If the two passwords do not match, the integrated social media platform 2 may prompt the user to reenter the passwords. If the passwords do match, the integrated social media platform 2 may update 212 the stored password for the user to the new password. The integrated social media platform 2 may display 214 a login page, for example, login screen 160, to the user for the user to login using the new password.

In some embodiments, a user may edit 216 the user data stored by the integrated social media platform 2. The integrated social media platform 2 may display a configuration page comprising the currently entered data for the user. The user may edit 216 the data displayed by the integrated social media platform 2. After editing 216 the data, the integrated social media platform 2 may update 218 the user data stored by the integrated social media platform 2.

In some embodiments, a user may add, remove, or update a linked social media network. A user may select 220 to remove or change a social media network. If a user indicates they wish to remove a linked social media network, the integrated social media platform 2 may display 222 the selected social media network's panel. The panel may include a remove button. A user may interact 224 with the remove button, for example, by clicking on the remove button. The integrated social media platform 2 may confirm 226 that the user wishes to remove the social network from the integrated social media platform 2. The integrated social media platform 2 may verify that the proper social media network profile is being removed by authenticating 228 the profile prior to removal. The integrated social media platform 2 may check 230 if the user is logged into the social media network. If the user is not logged into the social media network, the integrated social media platform 2 may request 232 login credentials to authenticate the social media network profile. If a user is logged into the social media network, the integrated social media platform 2 may remove 234 the social website for the user and may display an “Add” image in the social media panel.

In some embodiments, a user may change a linked social media network. The integrated social media platform 2 may display 236 the social media network panel. The user may make one or more changes to the social media network panel, for example, by adding a linked profile for the social media network, changing the login credentials for the social media network, or changing a homepage display for the social media network. The integrated social media platform 2 may confirm 240 the changes with the user. The integrated social media platform 2 may authenticate 242 the user account prior to making changes. The integrated social media platform 2 may check 244 if the user is logged into the social media network. If the user has not previously logged into the social media network, the integrated social media platform 2 may request 246 login credentials for the social media network. If the user has logged in to the social media network, the integrated social media platform 2 may update 248 the social media network information, for example, by adding a social media network or adding the changed details to the social media network profile for the user.

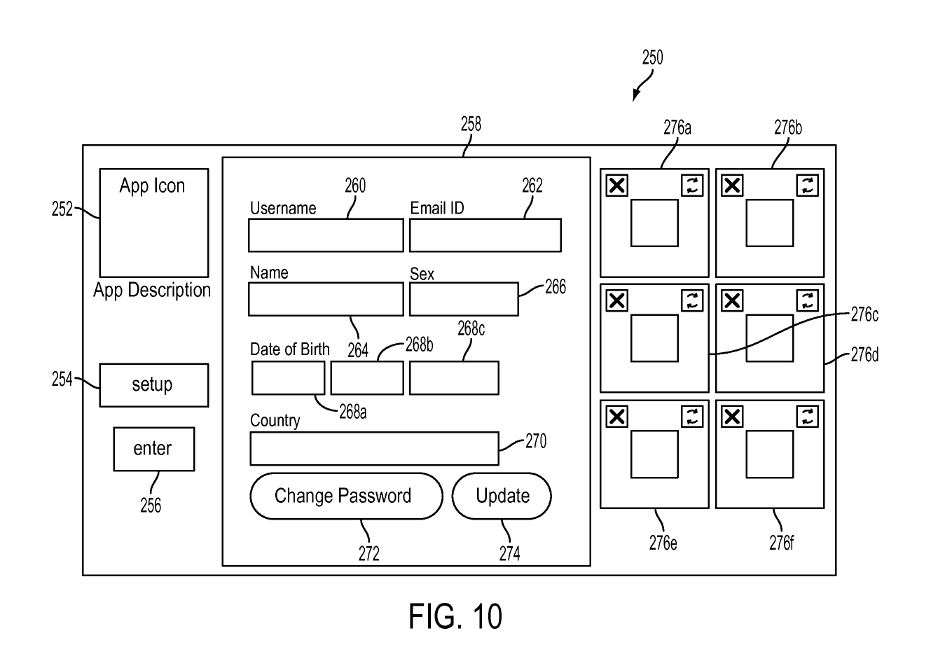

FIG. 10 illustrates on embodiment of a change account screen 250. The change account screen 250 may be configured to execute the process 200 illustrated in FIG. 9. An app icon 252 may be displayed to indicate the application or social media network associated with the displayed user information. A setup button 254 may be configured to allow a user to setup a new social media network or application not previously linked to the integrated social media platform 2. A user information box 258 may display the information of the user associated with the user's integrated social media platform 2 account and/or a selected social network account. A user may change information such as, for example, a username 260, an e-mail ID 262 associated with the account, the user's name 264, sex 266, date of birth 268a-268c, and/or country 270. In some embodiments, the user may not be able to change certain information once entered. For example, a user may not be able to alter a username and/or an email address once the user has registered with the integrated social media platform 2. An update button 274 may allow a user to update the information associated with the integrated social media platform 2. A change password button 272 may allow a user to change the password associated with the user's integrated social media platform 2 account. A user may select a social media button 276a-276f to add, remove, or change information associated with a specific social network account. For example, in some embodiments, the change account screen 250 may allow a user to update account information, add account information, or remove an account for one or more social networks, such as, for example, Facebook 276a, Twitter 276b, LinkedIn 276c, Vimeo 276d, YouTube 276e, and/or Dropbox 276f.

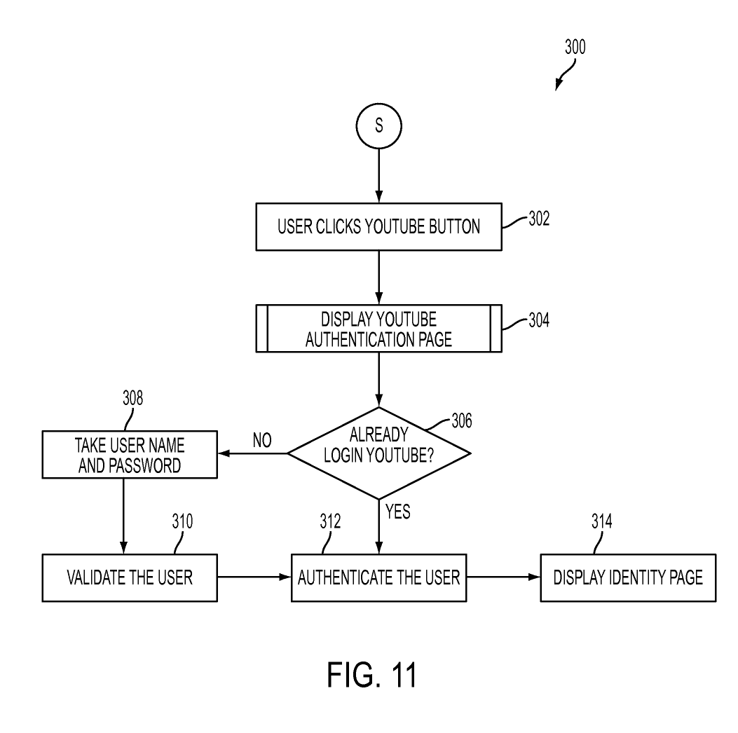

FIGS. 11-16 illustrate various processes for linking social networks to the integrated social media platform 2. For example, FIG. 11 illustrates a process 300 for linking a YouTube account to the integrated social media platform 2. A user may select 302 a YouTube button to link a YouTube account to the integrated social media platform 2. The YouTube button may be displayed, for example, on a user settings page and/or on a user's dashboard, such as, for example, the YouTube button 176e. The integrated social media platform 2 may display 304 a YouTube authentication page. The integrated social media platform 2 may check 306 to see if the user is logged in to a YouTube account. If the user is not logged into a YouTube account, the integrated social media platform 2 prompts 308 the user to enter a username and password for a YouTube account. The integrated social media platform 2 may validate 310 the user based on the entered username and password. Once the user has been validated, the integrated social media platform 2 may authenticate 312 the user. If the user is logged into YouTube when the integrated social media platform 2 checks 306, the integrated social media platform 2 authenticates 312 the user. Once the user has been authenticated, the integrated social media platform 2 may display 314 a social media identity page for the user comprising YouTube content in a top frame.

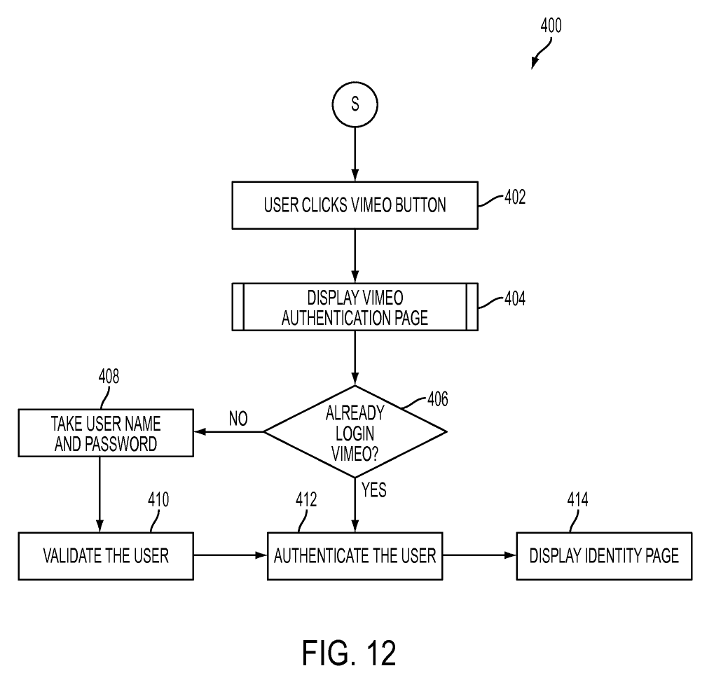

FIG. 12 illustrates one embodiment of a process 400 for linking a Vimeo account to the integrated social media platform 2. A user may interact 402 with the integrated social media platform 2, for example, by clicking a Vimeo button displayed to the user, for example, on the user's dashboard and/or on a settings page. The integrated social media platform 2 may display 404 a Vimeo authentication page. The integrated social media platform 2 may check 406 if the user is logged into a Vimeo account. If the user is logged into a Vimeo account, the integrated social media platform 2 may authenticate 412 the user and display 414 the identity page of the user including Vimeo content displayed in the top frame. If the user is not logged into a Vimeo account, the integrated social media platform 2 may display 408 a prompt for the user to enter the user's Vimeo username and password. The integrated social media platform 2 may validate 410 the user's Vimeo credentials and authenticate 412 the user's Vimeo account. The integrated social media platform 2 may display 414 a social media identity page for the user including Vimeo content in the top frame.

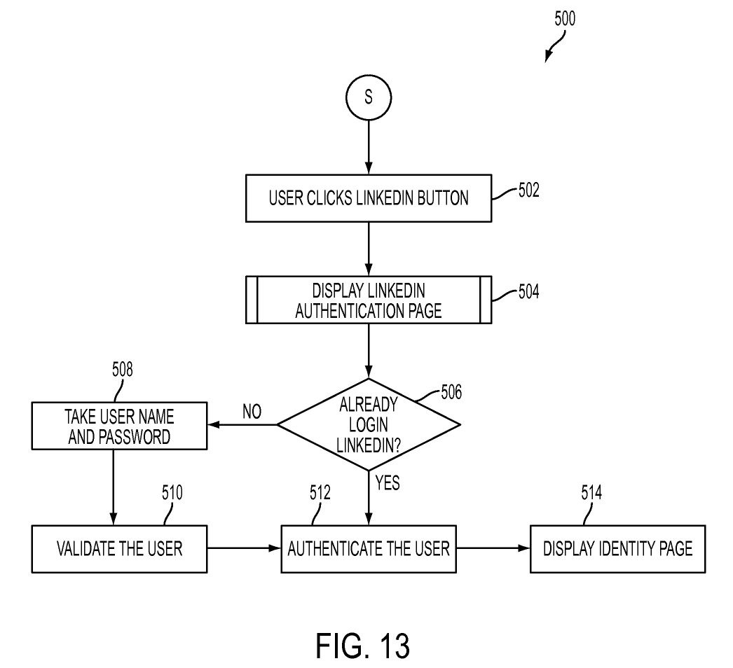

FIG. 13 illustrates one embodiment of a process 500 for linking a LinkedIn account to the integrated social media platform 2. A user may interact 502 with the integrated social media platform 2, for example, by clicking a LinkedIn button displayed to the user. The LinkedIn button may be displayed, for example, on a settings page and/or on the user's dashboard. The integrated social media platform 2 may display 504 a LinkedIn authentication page to the user. The integrated social media platform 2 may check 506 if the user is logged into a LinkedIn account. If the user is logged into a LinkedIn account, the integrated social media platform 2 authenticates 512 the user and may display 514 the user identity page including LinkedIn content. If a user is not logged into a LinkedIn account, the integrated social media platform 2 may prompt 508 a user to enter LinkedIn account credentials, such as, for example, a username and password. The integrated social media platform 2 may validate 510 the user provided LinkedIn credentials. If the credentials are validated, the integrated social media platform 2 may authenticate 512 the user and display 514 the user's social media identity page including LinkedIn content.

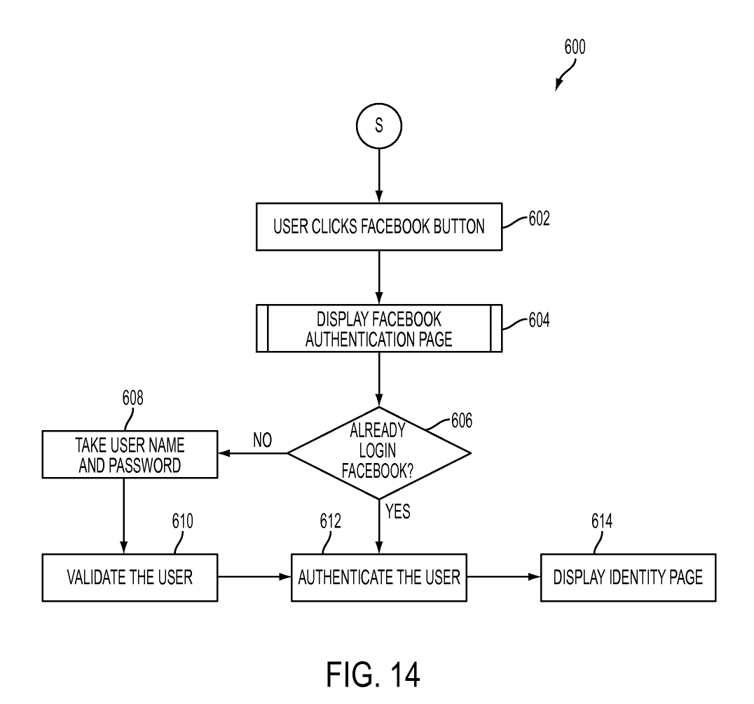

FIG. 14 illustrates one embodiment of a process 600 for linking a Facebook account to the integrated social media platform 2. A user may interact 602 with the integrated social media platform 2, for example, by clicking a Facebook button displayed to the user. The Facebook button may be displayed, for example, on a settings page and/or on the user's dashboard. The integrated social media platform 2 may display 604 a Facebook authentication page to the user. The integrated social media platform 2 may check 606 if the user is logged into a Facebook account. If the user is logged into a Facebook account, the integrated social media platform 2 may authenticate 612 the user and may display 614 the user's social media identity page including Facebook content. If a user is not logged into, or previously linked, a Facebook account, the integrated social media platform 2 may prompt 608 a user to enter Facebook account credentials, such as, for example, a username and password. The integrated social media platform 2 may validate 610 the user provided Facebook credentials. If the credentials are validated, the integrated social media platform 2 may authenticate 612 the user and display 614 the user's social media identity page including Facebook content.

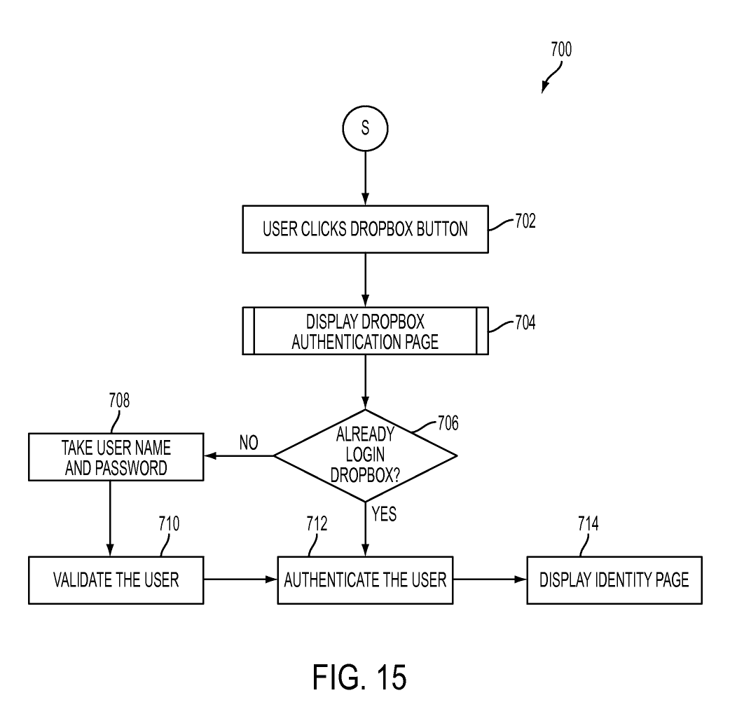

FIG. 15 illustrates one embodiment of a process 700 for linking a Dropbox account to the integrated social media platform 2. A user may interact 702 with the integrated social media platform 2, for example, by clicking a Dropbox button displayed to the user. The Dropbox button may be displayed, for example, on a settings page and/or on the user's dashboard, for example, the Dropbox button 276f displayed on the change account screen 250. The integrated social media platform 2 may display 704 a Dropbox authentication page to the user. The integrated social media platform 2 may check 706 if the user is logged into a Dropbox account. If the user is logged into a Dropbox account, the integrated social media platform 2 authenticates 712 the user and may display 714 the user's social media identity page including Dropbox content. If a user is not logged into, or previously linked, a Dropbox account, the integrated social media platform 2 may prompt 708 a user to enter Dropbox account credentials, such as, for example, a username and password. The integrated social media platform 2 may validate 710 the user provided Dropbox credentials. If the credentials are validated, the integrated social media platform 2 may authenticate 712 the user and display 714 the user's social media identity page, including Dropbox content

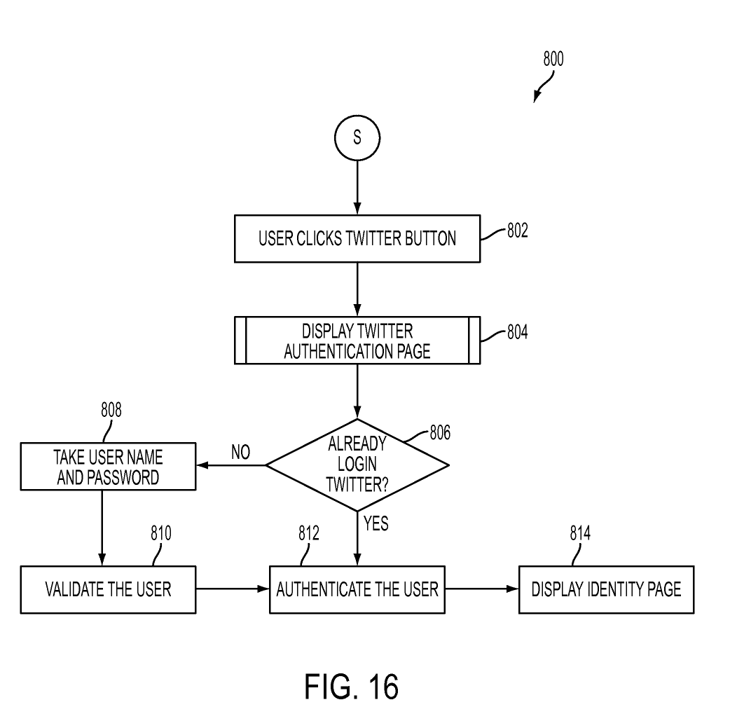

FIG. 16 illustrates one embodiment of a process 800 for linking a Twitter account to the integrated social media platform 2. A user may interact 802 with the integrated social media platform 2, for example, by clicking a Twitter button displayed to the user. The Twitter button may be displayed, for example, on a settings page and/or on the user's dashboard, for example, the Twitter button 276b displayed on the change account screen 250. The integrated social media platform 2 may display 804 a Twitter authentication page to the user. The integrated social media platform 2 may check 806 if the user is logged into a Twitter account. If the user is logged into a Twitter account, the integrated social media platform 2 authenticates 812 the user and may display 814 the user's social media identity page including Twitter content. If a user is not logged into a Twitter account, the integrated social media platform 2 may prompt 808 a user to enter Twitter account credentials, such as, for example, a username and password. The integrated social media platform 2 may validate 810 the user provided Twitter credentials. If the credentials are validated, the integrated social media platform 2 may authenticate 812 the user and display 814 the user's social media identity page, including Twitter content

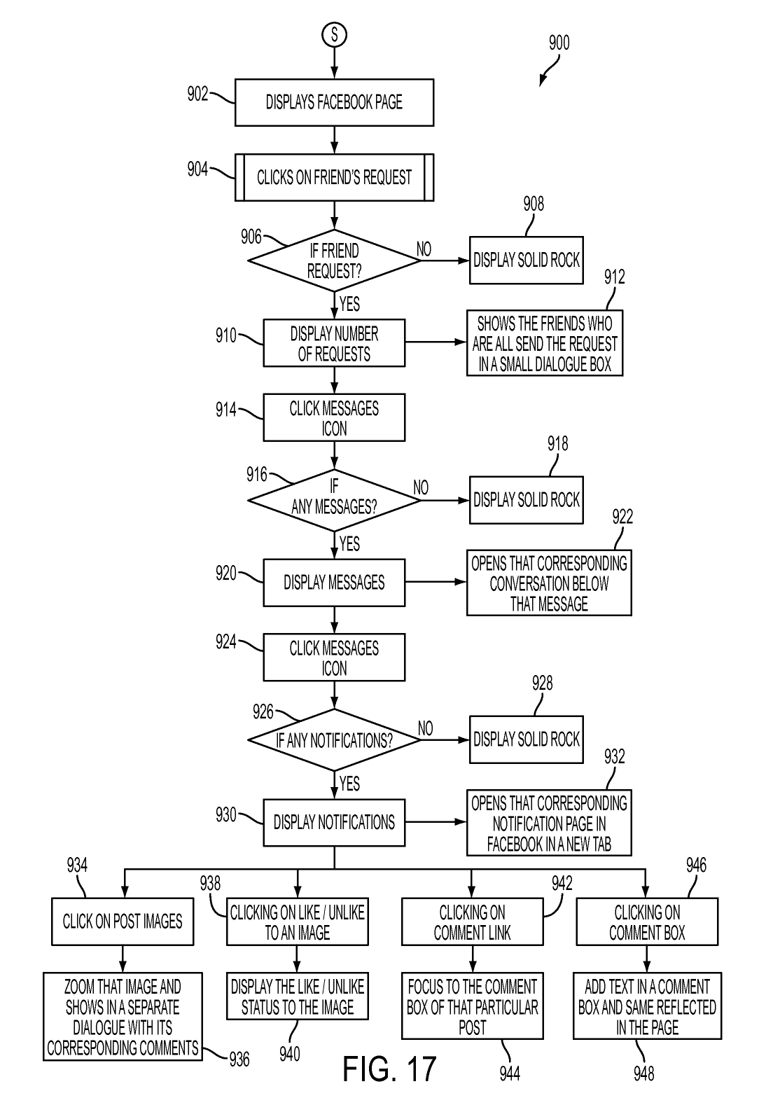

In some embodiments, the integrated social media platform 2 may allow a user to interact with one or more social networks through, for example, a user dashboard and/or a social media identity page. FIG. 17 illustrates one embodiment of a Facebook interaction process 900. A Facebook frame may be displayed on a user's social media identity page and/or on a user dashboard. The user may interact with the user's Facebook account through the user dashboard. For example, the integrated social media platform 2 may display 902 a user's Facebook page in a Facebook frame on the user's dashboard and/or social media identity page. The user may interact 904 with a friend request, for example, by clicking on a friend request icon. The integrated social media platform 2 may check 906 if there are any currently pending friend requests. If there are no current friend requests pending, the integrated social media platform 2 may display 908 an image, such as, for example, a solid rock, in the Facebook frame to indicate that there are no pending friend requests. If there are pending friend requests, the integrated social media platform 2 may display 910 the number of pending friend requests and may display 912 identifying information, such as, for example, a name, of the person who sent the friend request. A user may interact 914 with the Facebook frame, for example, by clicking on a message icon. The integrated social media platform 2 may check 916 if any messages are currently pending for the linked Facebook account. If there are no currently pending messages, the integrated social media platform 2 may display 918 an image, such as, for example, a solid rock, in the Facebook frame to indicate that there are no pending messages. If there are pending messages, the integrated social media platform 2 may display 920 the messages in the Facebook frame. The integrated social media platform 2 may display 922 conversations corresponding to messages below the displayed messages. A user may respond to a message by interacting with 924 the message icon, for example, by clicking on the message icon.

In some embodiments, the integrated social media platform 2 may check 926 for pending notifications for the linked Facebook account. If there are no pending notifications, the integrated social media platform 2 may display 928 an image, such as, for example, a solid rock, in the Facebook frame to indicate there are no pending notifications. If there are pending notifications, the integrated social media platform 2 may display 930 the pending notifications in the Facebook frame. In some embodiments, if a user interacts with a notification, for example, by clicking on the notification, the integrated social media platform 2 may open 932 a corresponding notification page in a separate browser tab. In some embodiments, a user may interact 934 with an image within the Facebook frame. The integrated social media platform 2 may modify 936 the Facebook frame, for example, to zoom in on the image and show a separate dialogue with corresponding comments for the image. A user may interact 938 with a like/unlike button for a post, image, or other element of the Facebook frame. The integrated social media platform 2 may display 940 the like/unlike status of the selected item, for example, an image. A user may interact 942 with a comment link displayed in the Facebook frame. The integrated social media platform 2 may focus 944 the Facebook frame on a comment box for a post related to the selected comment link. A user may interact 946 with a comment box to add 948 text to the comment box. The integrated social media platform 2 may update the user's Facebook account to post the comment entered in the comment box.

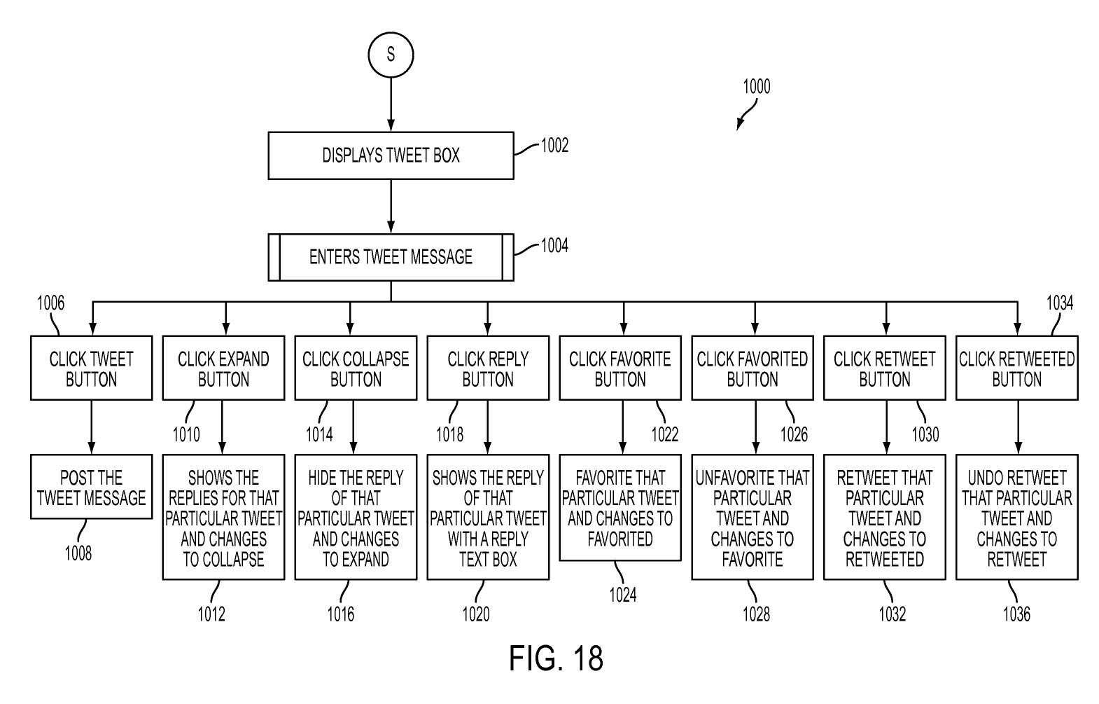

FIG. 18 illustrates one embodiment of a Twitter interaction process 1000. The integrated social media platform 2 may display 1002 a Twitter content, or tweet, box. The tweet box may be displayed, for example, on a user's social media identity page and/or on a user's dashboard. A user may enter 1004 tweet messages into the tweet box. The integrated social media platform 2 may provide a tweet button. The user may interact 1006 with the tweet button to post a tweet message entered by the user. The user may select 1010 an expand button for a displayed tweet. The integrated social media platform 2 may display 1012 replies for the selected tweet. The user may select 1014 a collapse button for a previously expanded tweet. The integrated social media platform 2 may hide 1016 the replies for the selected tweet in response to the user selecting 1014 the collapse button. A user may select 1018 a reply button displayed within the tweet box. The integrated social media platform 2 may display 1020 the current replies to the selected tweet and may display 1020 a text box for entering a reply to the selected tweet. A user may select 1022 a favorite button for a displayed tweet. If the user has not previously selected 1022 the favorite button for the displayed tweet, the integrated social media platform 2 may add 1024 the displayed tweet to the user's favorites. If the user selects 1026 the favorite button after the tweet has been added to the user's favorites, the integrated social media platform 2 may remove 1028 the tweet from the user's favorites. A user may select 1030 a retweet button. The integrated social media platform 2 may retweet the selected tweet in response to the user selecting 1030 the retweet button. If a user reselects 1034 the retweet button, the integrated social media platform 2 may undo 1036 the retweet of the selected tweet in response.

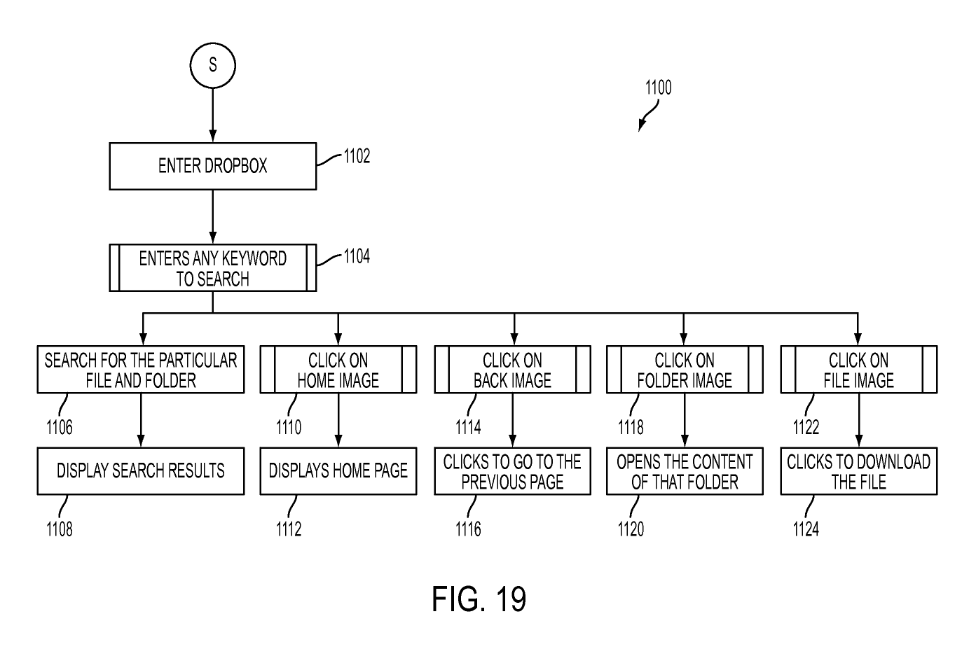

FIG. 19 illustrates one embodiment of a Dropbox interaction process 1100. A user may select 1102, or enter, a Dropbox frame or Dropbox display. For example, a user may select a Dropbox frame displayed on the user's social media identity page and/r on the user's dashboard. The integrated social media platform 2 may receive 1104 keywords to search from the user. The integrated social media platform 2 may search 1106 the Dropbox account for files and folders matching the entered keywords. The integrated social media platform 2 may display 1108 the search results to the user. A user may select 1110 a home image. The integrated social media platform 2 may display 1112 the homepage of the Dropbox account in response to the selection 1110 of the home image. The integrated social media platform 2 may provide one or more navigation buttons, such as, for example, a forward and/or a back button for navigation within the Dropbox frame. A user may select 1114 the back image/button. The integrated social media platform 2 may load 1116 the previous page and/or document in response to the selection 1114 of the back button by the user. A user may select 1118 an image of a folder displayed, for example, in response to a search request. The integrated social media platform 2 may open 1120 the folder and display the contents of the folder to the user. The user may select 1122 a file displayed in the Dropbox frame, for example, a file displayed in response to opening a folder. The integrated social media platform 2 may download 1124 and/or display the file in response to the selection 1122 by the user.

In some embodiments, the integrated social media platform 2 may provide one or more network interactions 90, as illustrated in FIG. 4. A network interaction may comprise an interaction between the user and the integrated social media platform 2 that is not directly communicated and/or broadcast to social media networks linked to the integrated social media platform 2. For example, in some embodiments, a network interaction may comprise changing one or more settings of the social media identity page and/or the user dashboard, installing one or more games, installing one or more widgets/gadgets, and/or completing one or more financial transactions.

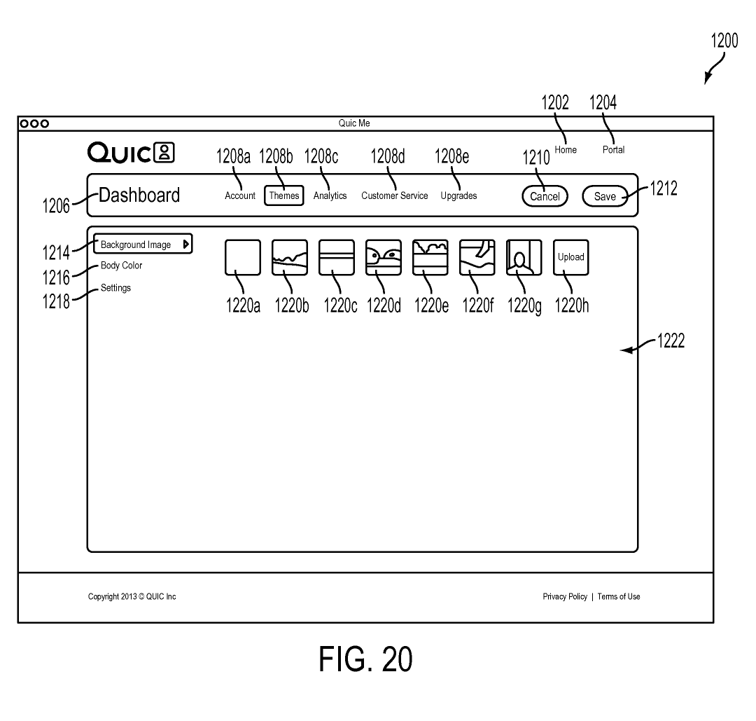

In some embodiments, the integrated social media platform 2 may comprise a dashboard interface to manage one or more network interactions 90 between the user and the integrated social media platform 2. FIG. 20 illustrates one embodiment of a dashboard theme management screen 1200. The theme management screen 1200 may provide controls for one or more aspects of the user's integrated social media platform 2 account, the user's dashboard page, and/or a social media identity page. The theme management screen may comprise a home button 1202 and/or a portal button 1204. The home button 1202 may direct a user to the user's dashboard. The portal button 1204 may direct the user to the user's social media identity page. The home button 1202 and the portal button 1204 may be displayed on all pages of the integrated social media platform 2 to allow users to quickly access the most common pages of the integrated social media platform 2.

The theme management screen 1200 may comprise a navigation bar 1206. The navigation bar 1206 may allow a user to quickly switch between the theme management screen and one or more additional dashboard screens, for example, an account management button 1208a may load an account management screen, an analytics button 1208c may load an analytics screen, a customer service button 1208d may load a help screen, and an upgrades button 1208e may load a widgets/gadgets screen. The theme management screen 1200 may comprise one or more tabs for managing features of a user's dashboard and/or social media identity page. For example, the theme management screen 1200 may comprise a background image tab 1214. The background image tab 1224 may display a list of available backgrounds 1220a-1220h. The user may select a background image 1222 to be displayed for one or more pages of the integrated social media platform 2, such as, for example, the user's dashboard and/or the user's social media identity page. In some embodiments, a user may upload one or more additional backgrounds to the integrated social media platform 2. A body color tab 1216 may allow a user to customize one or more features of the dashboard and/or the social media identity page, such as, for example, the color of the text, color of the text background, or the color of one or more sections of, for example, a social media identity page. A settings tab 1218 may allow a user to change one or more settings for the integrated social media platform 2, the user's dashboard, and/or the user's social media identity page, such as, for example, changing the size of each social network's field on the social media identity page or changing which accounts are displayed on the dashboard and/or the social media identity page.

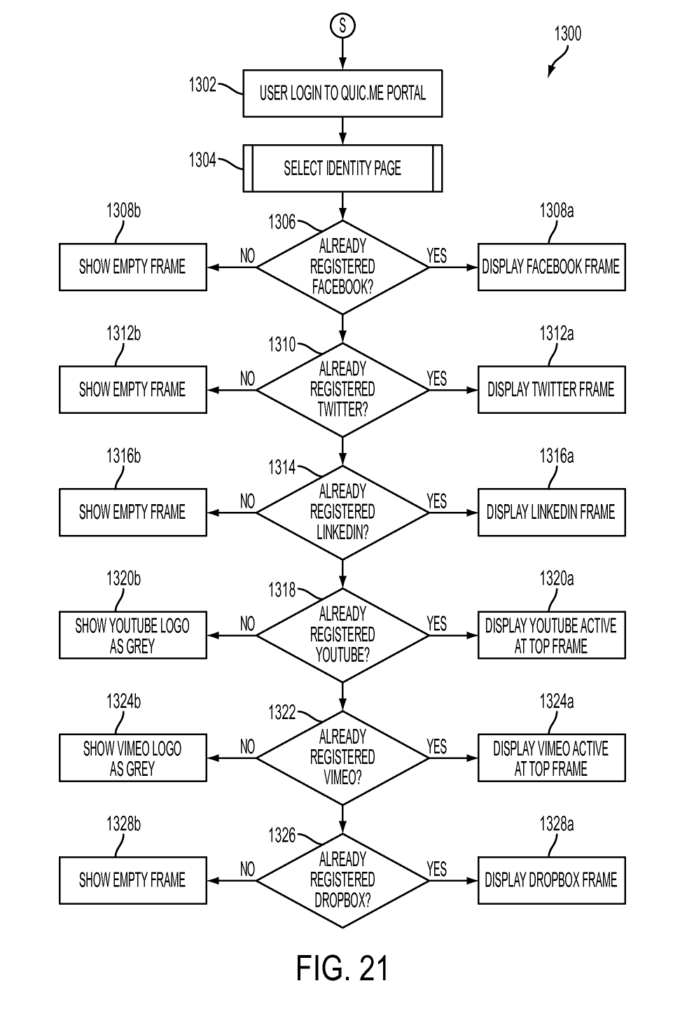

In some embodiments, the integrated social media platform 2 may be configured to generate a social media identity page. FIG. 21 illustrates one embodiment of a social media identity page generation process 1300. A user may login 1302 to the integrated social media platform 2, for example, by entering a URL associated with the integrated social media platform 2 into a user's web browser and entering the user's credentials. The user may select 1304 a social media identity page for a specific user to be displayed. The specific user may be the user or may be another user of the integrated social media platform 2, such as, for example, an individual, a corporation, or any other entity having a social media presence. The integrated social media platform 2 may check 1306 if the specific user has registered a Facebook account with the integrated social media platform 2. If the specific user has registered a Facebook account, the integrated social media platform 2 may display 1308a a Facebook frame on the social media identity page. If the specific user has not registered a Facebook account with the integrated social media platform 2, the integrated social media platform 2 may display 1308b an empty frame in place of the Facebook frame. The integrated social media platform 2 may check 1310 if the specific user has registered a Twitter account. If the specific user has registered a Twitter account, the integrated social media platform 2 may display 1312a a Twitter frame on the social media identity page. If the specific user has not registered a Twitter account, the integrated social media platform 2 may display 1312b an empty frame.

The integrated social media platform may check 1314 if the specific user has registered a LinkedIn account. If the specific user has registered a LinkedIn account, the integrated social media platform 2 may display 1316a a LinkedIn frame on the social media identity page. If the specific user has not registered a LinkedIn account with the integrated social media platform 2, the integrated social media platform 2 may display 1316b an empty frame in place of the LinkedIn frame. The integrated social media platform may check 1318 if the specific user has registered a YouTube account with the integrated social media platform 2. If the specific user has registered a YouTube account, the integrated social media platform 2 may display 1320a a top frame comprising YouTube content on the social media identity page. If the specific user has not registered a YouTube account, the integrated social media platform 2 may display 1320b an empty top frame, may display Vimeo content in the top frame, or may display a gray or faded YouTube logo in the top frame. The integrated social media platform 2 may check 1322 if the specific user has registered a Vimeo account with the integrated social media platform 2. If the specific user has registered a Vimeo account, the integrated social media platform 2 may display 1324a Vimeo content in the top frame. If the use has not registered a Vimeo account, the integrated social media platform 2 may display 1324b an empty top frame, may display YouTube content in the top frame, or may display a gray or faded Vimeo logo in the top frame. The integrated social media platform 2 may check 1326 if the specific user has registered a Dropbox account. If the specific user has registered a Dropbox account, the integrated social media platform 2 may display 1328a a Dropbox frame. If the specific user has not registered a Dropbox account, the integrated social media platform 2 may display 1328b an empty frame in place of the Dropbox frame.

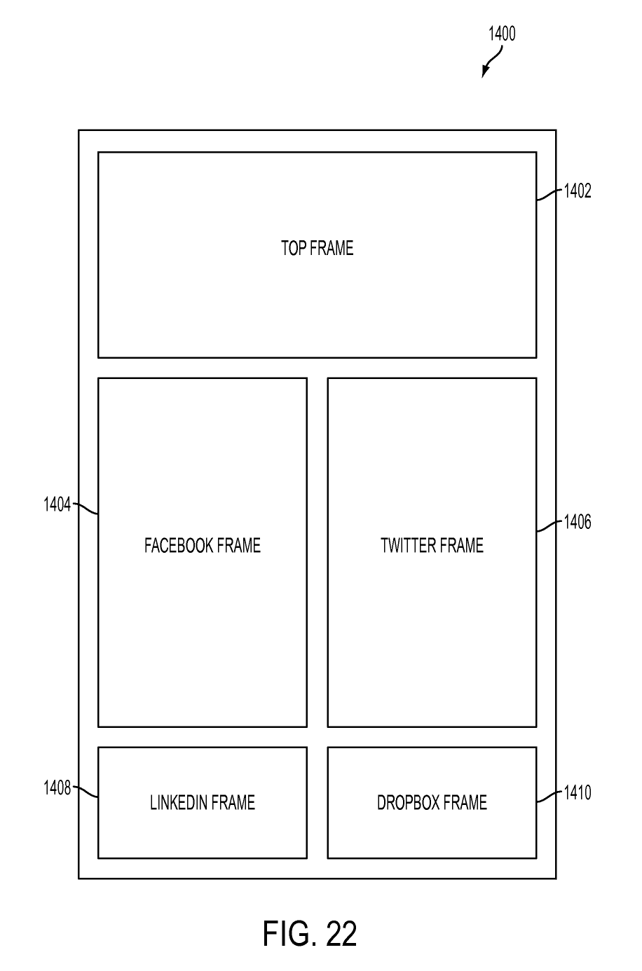

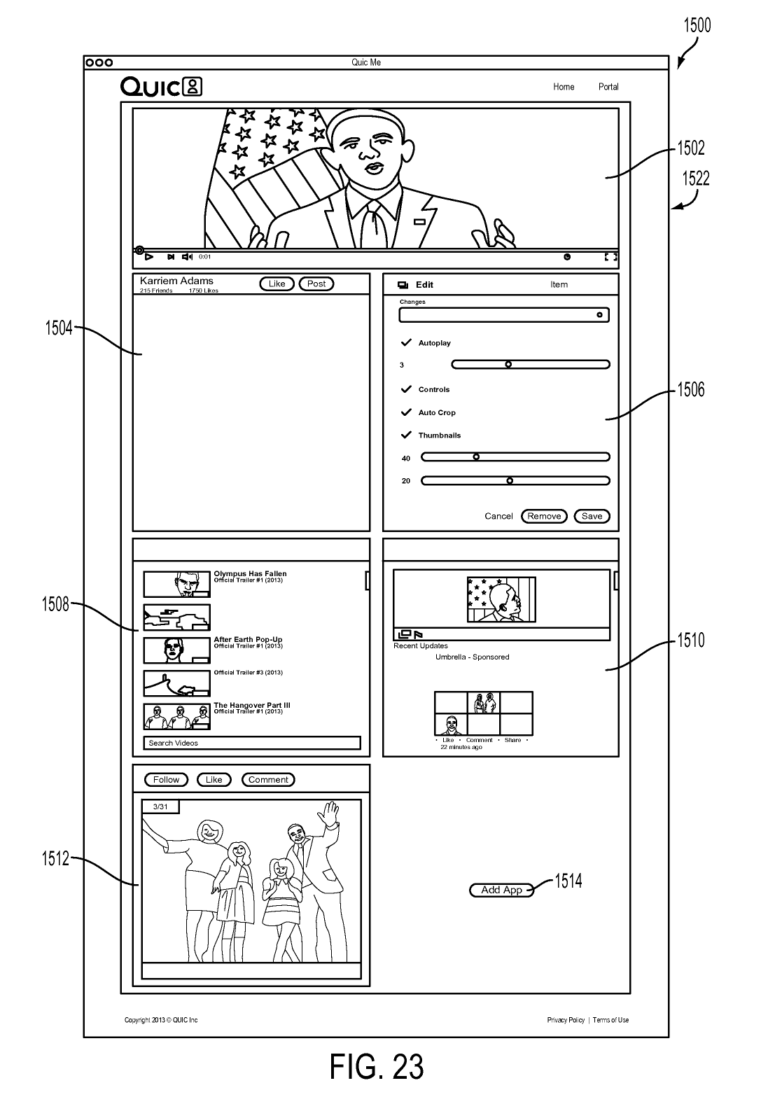

FIGS. 22 and 23 illustrates various embodiments of social media identity pages. As illustrated in FIG. 22, a social media identity page 1400 may comprise one or more social media fields 1402-1410. The social media fields 1402-1410 may be populated by the integrated social media platform 2 with content from one or more linked social networks and/or content provided directly to the integrated social media platform 2. For example, as discussed with respect to FIG. 21, integrated social media platform 2 may be linked to a YouTube account. The integrated social media platform 2 may load content from the linked YouTube account, for example, by loading favorite videos. The integrated social media platform 2 may display the YouTube content in a top field 1402. In some embodiments, if a YouTube account has not been linked to the integrated social media platform 2, the integrated social media platform 2 may load content from a linked Vimeo account in the top field 1402. If neither a YouTube account nor a Vimeo account has been linked to the integrated social media platform 2, the integrated social media platform 2 may display a login page for YouTube and/or Vimeo in the top field 1402. The top field 1402 may allow a user to play a video from the specific user's YouTube account or Vimeo account, play a playlist stored in the specific user's YouTube account or Vimeo account, and/or generate new playlists from the content of the specific user's YouTube account or Vimeo account. In some embodiments, if the user and the specific user are the same, the user may be able to manage the user's YouTube or Vimeo account through the top frame 1402.

In some embodiments, the social media identity page 1400 may comprise a Facebook network field 1404. The Facebook network field 1404 may display content from the specific user's Facebook account. In some embodiments, if the user and the specific user are the same, the integrated social media platform 2 may allow the user to manage the linked Facebook account through the Facebook network field 1404. If the user and the specific user associated with the social media identity page are the same, the Facebook network field 1404 may display a prompt for a user to add and/or authenticate a Facebook account to the integrated social media platform 2. In some embodiments, authentication may require the user to “Like” the integrated social media platform 2 page on Facebook. Once a Facebook account has been linked to the integrated social media platform 2, the Facebook network field 1404 may display content from the linked Facebook account, for example, by displaying a specific user's Facebook messages, notifications, friend requests, posts, timelines, and/or news feed. The Facebook network field 1404 may allow a user to respond to the content displayed in the specific user's Facebook frame 1404. For example, the Facebook network field 1404 may allow a user to interact with and obtain the details of one or more friend requests, notifications, and/or messages, may allow a user to initiate and/or respond to one or more Facebook chat conversations, and view one or more images from the user's Facebook account, including being able to access “Like” or “Unlike” functionality of the user's Facebook account.

In some embodiments, the social media identity page 1400 may comprise a Twitter network field 1406. The Twitter network field 1406 may display content from the specific user's Twitter account. The Twitter network field 1406 may require the specific user to authenticate a Twitter account for example, by entering the user's Twitter credentials, following the integrated social media platform 2 on Twitter, and/or providing additional authentication of the user's Twitter account prior to displaying the Twitter content. The Twitter network field 1406 may provide functionality to a user as though the user had directly accessed the specific user's Twitter account. For example, the Twitter network field 1406 may comprise a Tweet box to allow a user to enter a tweet and a Tweet button to transmit the tweets entered into the Tweet box. An expand link may expand replies for a specific tweet displayed. A reply link may allow a user to reply to a specific Tweet, such as, for example, a tweet by the specific user. A favorite link may add a Tweet to the user's favorites and a retweet button may allow a user to retweet a specific tweet.

In some embodiments, the social media identity page 1400 may comprise a LinkedIn network field 1408. The LinkedIn network field 1408 may display content from a user's LinkedIn account. The LinkedIn network field 1408 may require the specific user to link a LinkedIn account by, for example, entering a user's LinkedIn credentials, such as a username and password, promoting a LinkedIn page for the integrated social media platform 2, and/or verifying the user's LinkedIn profile. The LinkedIn network field 1408 may display, for example, a user's LinkedIn profile and/or requests and messages from other LinkedIn users.

In some embodiments, the social media identity page 1400 may comprise a Dropbox network field 1410. The Dropbox network field 1410 may display content from a linked Dropbox account. The Dropbox network field 1410 may require the specific user to authenticate the specific user's Dropbox account, for example, by entering Dropbox credentials, before the Dropbox content is displayed. The Dropbox network field 1410 may provide the same functionality as if a user had accessed the specific user's Dropbox account directly. For example, in some embodiments, the Dropbox network field 1410 may allow a user to search the specific user's files using a search box. A user may enter a keyword into the search box to search against the file names previously uploaded to the Dropbox account. A search button may initiate the search. A home icon may allow the user to easily access the specific user's Dropbox homepage. Navigation buttons, such as, for example, a forward and/or a backward button, may be displayed to allow a user to navigate a selected document. One or more folder icons and one or more file icons may be displayed to allow a user to access the folder structure and open specific files stored in the specific user's Dropbox account. In some embodiments, the Dropbox network field 1410 may allow scribbling in a selected Dropbox file, for example, by using a virtual pen or highlighter. The Dropbox network filed 1410 may allow a user to broadcast one or more files stored in the specific user's Dropbox account. The Dropbox network field 1410 may allow a user to open a new file, open an image file stored on the desktop/in the Dropbox account, and/or upload new files to the Dropbox account.

FIG. 23 illustrates one embodiment of social media identity page 1500. The social media identity page 1500 is similar to the social media identity page 1400 illustrated in FIG. 22. The social media identity page 1500 comprises a top frame 1502 configured to display YouTube content. A Facebook frame 1504 may display content from a linked Facebook account. In the illustrated embodiment, the social media identity page 1500 comprises a YouTube settings frame 1506 and a YouTube playlist frame 1508. The YouTube settings frame 1506 may allow a user, for example, the specific user associated with the social media identity page 1500, to modify the settings for displayed YouTube content, such as, for example, the YouTube content displayed in the top frame 1502. The YouTube playlist frame 1508 may allow a user to select one or more additional videos from the specific user's pre-stored YouTube playlists. The social media identity page 1500 may comprise a LinkedIn frame 1510. In the illustrated embodiment, the specific user associated with the social media identity page has linked a Pinterest account to the integrated social media platform 2 and the integrated social media platform 2 has generated a Pinterest frame 1512 for the specific user's social media identity page 1500. The social media identity page 1500 may comprise an empty frame 1514, for example, if a user has not linked enough social media networks to fill all of the frames and/or if a user has selected not to display a specific social network. In some embodiments, the integrated social media platform 2 may imbed one or more applications into a frame on the social media identity page 1500, for example, in the empty frame 1514. Embedded applications may comprise, for example, games, widgets, and or gadgets available through the integrated social media platform 2.

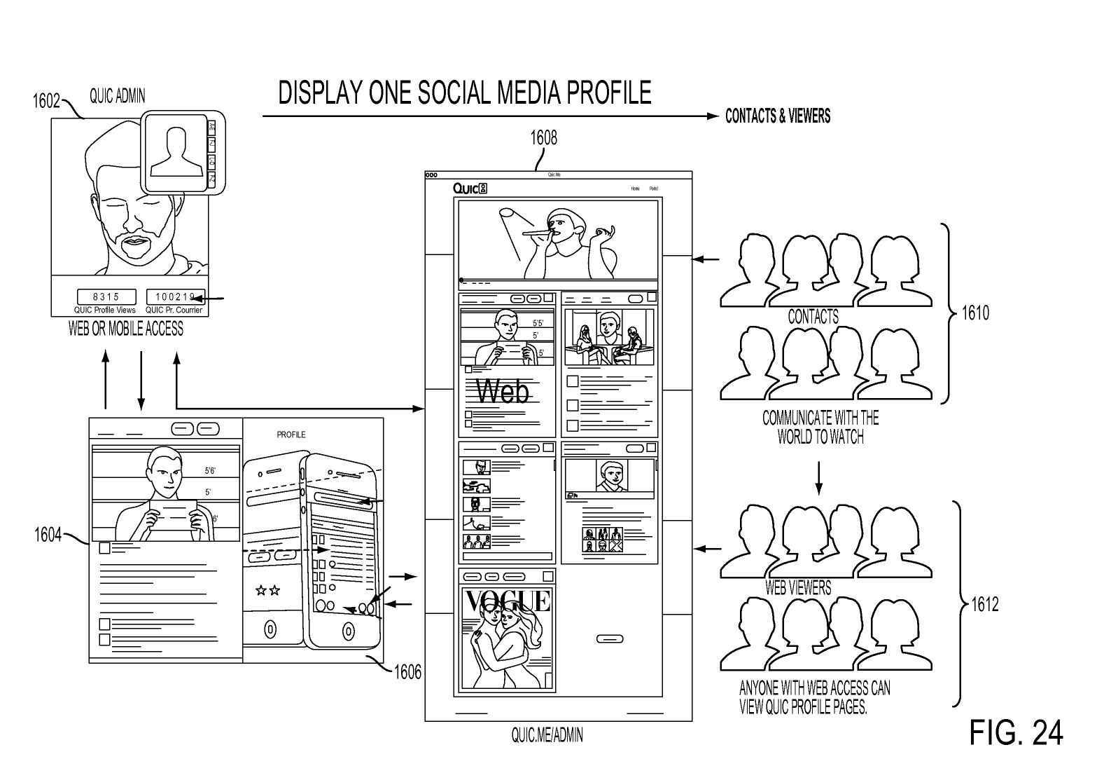

FIG. 24 illustrates one embodiment a social media interaction 1600 between executed by the user using the integrated social media platform 2. An administrator 1602 may manage a social media identity page 1608 by accessing the administrator's dashboard, such as, for example, through a client device, such as, for example, a mobile device 1604. The administrator 1602 may generate notifications to one or more of, including all of, the administrator's social media contacts and/or imported contacts, such as, for example, email and text contacts stored on the client device, through a single interaction with the user's dashboard. The administrator 1602 may update, make changes, post updates, add pictures, add videos, and/or add any additional content to one or more of the linked social networks through a single interaction with the integrated social media platform 2. The integrated social media platform 2 may transmit text and/or email notifications to the administrator 2 when one or more users visit the administrator's 1602 social media identity page 1608. Users may view the administrator's 1602 social media identity page 1608. Users viewing the administrator's 1602 identity page 1608 may comprise social media contacts 1610 of the administrator and/or non-contact web viewers 1612.

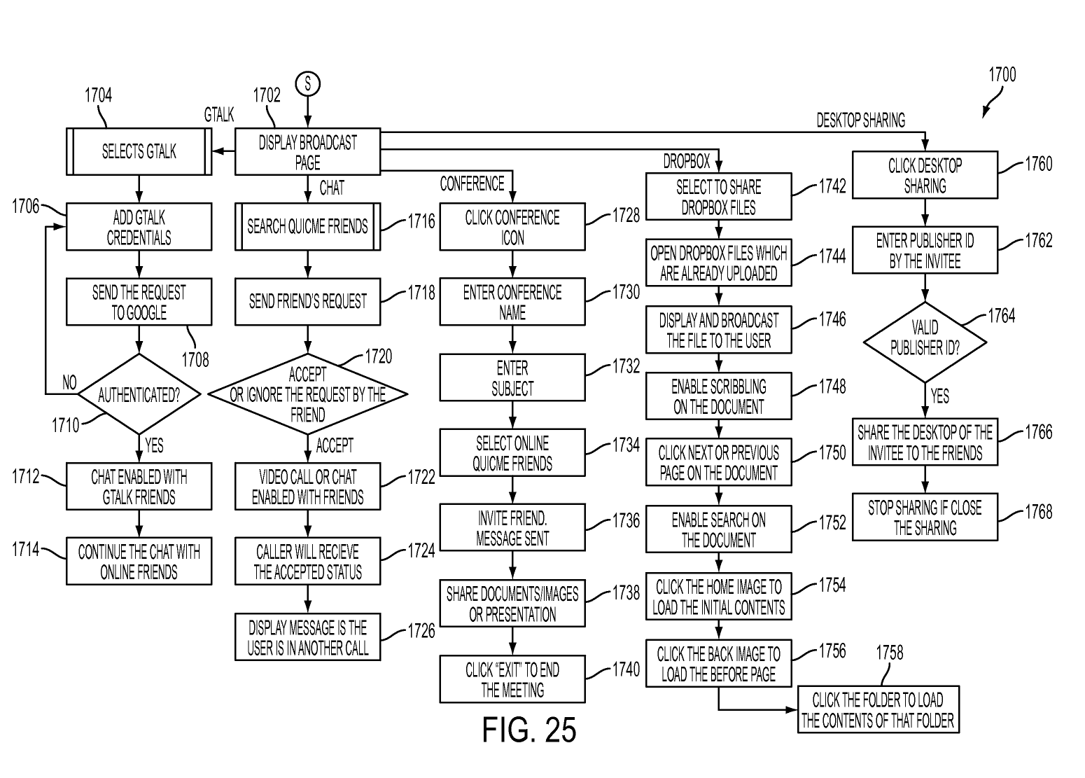

In some embodiments, the integrated social media platform 2 may execute one or more broadcast interactions. As discussed above with respect to FIG. 3, a broadcast interaction may comprise a social media interaction, such as, for example, posting content, initiating a chat session, initiating a conference session, initiating a webcast, updating user information, or otherwise interacting with one or more social media networks and/or social media contacts. FIG. 25 illustrates one embodiment of a broadcast interaction process 1700. The integrated social media platform 2 may display 1702 a broadcast page on the dashboard configured to allow the user to initiate one or more broadcast interactions. The user may select 1704 a Google Talk broadcast interaction. A Google Talk broadcast interaction may comprise a Google Talk interaction between the user and one or more social media contacts. When a user initiates 1704 a Google Talk broadcast interaction, the integrated social media platform 2 may add 1706 Google Talk credentials to the integrated social media platform 2, such as, for example, by prompting the user to enter a username and password for a Google account. The integrated social media platform 2 may send 1708 the entered Google Talk credentials to Google for authentication. The integrated social media platform 2 may check 1710 if the Google Talk credentials have been authenticated. If the credentials have been authenticated, the integrated social media platform 2 may enable 1712 a Google Talk chat session with one or more Google Talk friends, other social media contacts, and/or imported contacts. The Google Talk chat session may be displayed within a frame of a page of the integrated social media platform 2, such as, for example, in a frame on the user's dashboard. The user may simultaneously engage in a Google Talk chat and interact with other social media networks and/or applications linked to the integrated social media platform 2. If one or more of the user's friends is disconnected from the chat session, the integrated social media platform 2 may continue 1714 the Google Talk chat with only those friends remaining online. If the integrated social media platform 2 is unable to authenticate the user's Google credentials, the integrated social media platform 2 may prompt the user to reenter the user's credentials.

In some embodiments, a user may initiate one or more broadcast interactions with specific friends by selecting those friends from a friend list. The integrated social media platform 2 may enable, for example, initiating a one-to-one text chat with a single friend, initiating a one-to-one video chat with a single friend, receiving a video chat request from a friend, ignoring a video chat request from a friend, and receiving notifications regarding the status of sent and/or received requests for interaction. In some embodiments, the integrated social media platform 2 may be configured to notify the user if a friend is engaged in another chat, such as, for example, a video chat, and may send a notification to the friend that the user attempted to initiate a broadcast interaction while the friend was engaged in another chat session. If a broadcast interaction request is accepted, the integrated social media platform 2 may activate one or more plug-ins to facilitate the requested chat. For example, in some embodiments, the integrated social media platform 2 may activate a video chat plug-in to enable a user's camera and microphone for a video chat and to deactivate the user's video and microphone after the video chat.

In some embodiments, a user may initiate a conference broadcast interaction. A conference broadcast interaction may comprise a chat request with one or more users using the XMMP plug-in and/or ay other suitable chat application. The integrated social media platform 2 may generate a chat room and may allow the user and one or more invited contacts to enter the chat room. In some embodiments, the user may initiate a Google Talk chat session using the Google Talk button. The Google Talk button may generate a Google Talk request for one or more friends highlighted in the friend's list. The integrated social media platform 2 may send the request, authenticate the user's Google Talk account, and connect the user through Google Talk to one or more friends. In some embodiments, a search button may display a search box to allow a user to search for one or more friends in the friends list.

In some embodiments, a user may initiate a chat broadcast interaction. A chat broadcast interaction may be executed using a chat program embedded in the integrated social media platform 2, such as, for example, the XMPP messaging plug-I 14d. The integrated social media platform 2 may search 1716 for the user's social media friends who are online. The integrated social media platform 2 may limit the search, for example, to a specific social media network, such as, for example, searching only for friends of the user who are also users of the integrated social media platform 2. The integrated social media platform 2 may search for users of a specific social media network, for example, the integrated social media platform 2, and may limit the search to profiles that are not friends with the user. The integrated social media platform 2 may send 1718 a friend request to other users identified by the search. Upon receiving a friend request, the contact may choose 1720 to accept or deny the friend request. Once a user is connected other users as friends, the user may initiate one or more chat broadcast interactions with the user's friends. The integrated social media platform 2 may initiate 1722 a video call or video chat with one or more video enabled friends. The user initiating the chat broadcast interaction may receive 1724 a status updated regarding the chat broadcast interaction from the integrated social media network. If one or more of the user's friends are already involved in a chat broadcast interaction, the integrated social media platform 2 may notify 1726 the user that one or more friends are not available. In some embodiments, a user device may require certain hardware to connect to and/or initiate specific type of broadcast interaction. For example, a client device may require a video camera and a microphone in order to connect to and/or initiate a video chat session.

In some embodiments, a user may select 1728 a conference broadcast interaction. A conference broadcast interaction may comprise one or more simultaneous broadcast interactions, such as, for example, simultaneous video chat, text chat, audio chat, document sharing, and/or desktop sharing. The integrated social media platform 2 may prompt 1730 the user to enter a conference name for the conference. The user may enter 1732 a subject for the conference. The name and subject for the conference may be entered, for example, into one or more text boxes displayed on the user's dashboard. The user may select 1734 one or more online contacts/friends to invite to the conference. The contacts may be selected from one or more social media networks, for example, selecting friends linked through the integrated social media platform 2 and/or one or more imported contacts. A user may share 1738 documents, images, or presentations during a conference through the integrated social media platform 2. The user may select 1740 an exit button to exit and/or end a conference.

In some embodiments, a user may select 1742 a Dropbox file sharing broadcast interaction. The Dropbox file sharing broadcast interaction may be selected as an independent broadcast interaction or as part of a conference broadcast interaction. The integrated social media platform 2 may open 1744 one or more Dropbox files that have been previously uploaded to the user's Dropbox account in a Dropbox frame displayed on the user's dashboard. The integrated social media platform 2 may display 1744 the one or more Dropbox files to the user and may broadcast 1744 the files to one or more friends identified by the user. In some embodiments, the integrated social media platform 2 may enable 1748 scribbling within the documents. Scribbling may comprise generating notes, images, or other markings using a digital pen within a document. The user may navigate 1750 the document, for example, by selecting next or previous page buttons. The integrated social media platform 2 may enable 1752 searching within the document, for example, enabling keyword searches. The user may select 1754 a home button within a Dropbox frame to load a Dropbox homepage. A user may select 1756 a back button to go to the previous page within the Dropbox frame. In some embodiments, a user may select 1758 a folder to display the contents of the folder within the Dropbox frame.

In some embodiments, a user may select 1760 a desktop sharing broadcast interaction. The desktop sharing broadcast interaction may be selected 1760 as an independent broadcast interaction or as part of one or more additional broadcast interactions, such as, for example, as part of a conference broadcast interaction. When a user selects 1760 desktop sharing, one or more invitees may connect to the integrated social media platform 2 to view the shared desktop. The invitees may enter 1762 a publisher ID to verify that the invitee is authorized to view the shared desktop. The integrated social media platform 2 may verify 1764 the publisher ID provided by the invitee. If the integrated social media platform 2 is able to verify 1764 the publisher ID, the integrated social media platform 2 may initiate 1766 sharing of the user's desktop with the invitee. If the user disconnects or closes the desktop sharing frame, the integrated social media platform 2 may stop 1768 sharing the desktop.

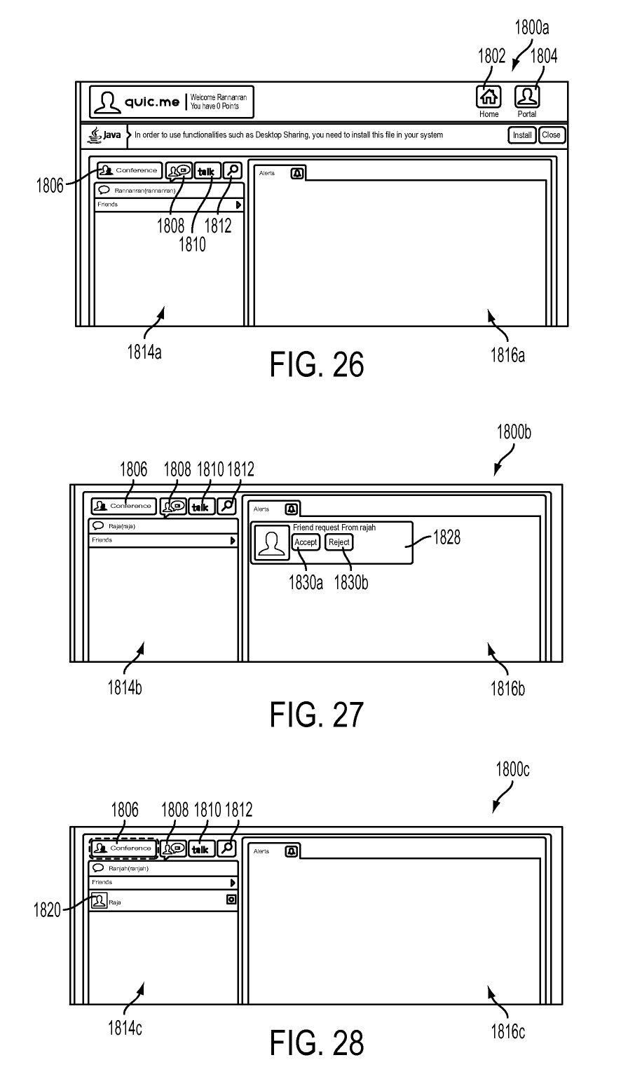

FIGS. 26-31 illustrate various embodiments of a dashboard broadcast screen. FIG. 26 illustrates a dashboard broadcast screen 1800a. The broadcast screen 1800a comprises a home button 1802 and a portal button 1804. The home button 1802 and the portal button 1804 are similar to the home button 1202 and the portal button 1204 discussed with respect to FIG. 20. The dashboard broadcast screen 1800a may allow a user to initiate one or more broadcast interactions through the integrated social media platform 2. For example, in some embodiments, the broadcast screen 1800a may comprise a conference button 1806. The conference button 1806 may initiate a conference broadcast interaction through the integrated social media platform 2, such as, for example, by accessing a SeshConference plug-in. In some embodiments, a friend list 1814a may display one or more friends of the user who are online and/or are available for a broadcast interaction. The broadcast screen 1800 may comprise a chat button 1808, a Google Talk button 1810, and/or a search button 1812. An alert area 1816a may be configured to display one or more received alerts. In some embodiments, a user may add friends to the friend list by sending friend requests through the integrated social media platform 2 and/or one or more linked social networks. If a potential friend accepts a friend request, the friend may be displayed in the friend's list 1814a. In some embodiments, if a potential friend rejects a friend request, the potential friend may be displayed in the friend's list 1814a with an indication that the potential friend did not accept the friend request. In some embodiments, the friend list 1814a maybe populated based on the one or more linked social networks.

FIG. 27 illustrates one embodiment of a broadcast screen 1800b displaying a friend request 1828 received from a second user. The friend request 1828 is displayed in the alert area 1816b. The friend request 1828 may comprise an accept button 1830a and a reject button 1830b. If the user selects the accept button 1830a, the second user may be added as friend 1820 to the users friend list 1814b. Once the second user has been added as a friend 1820, the user may initiate one or more broadcast interactions with the friend 1820. As shown in FIG. 28, once a user has responded to a fried request 1828, either by accepting or rejecting the friend request 1828, the friend request 1828 is removed from the alert area 1816c.

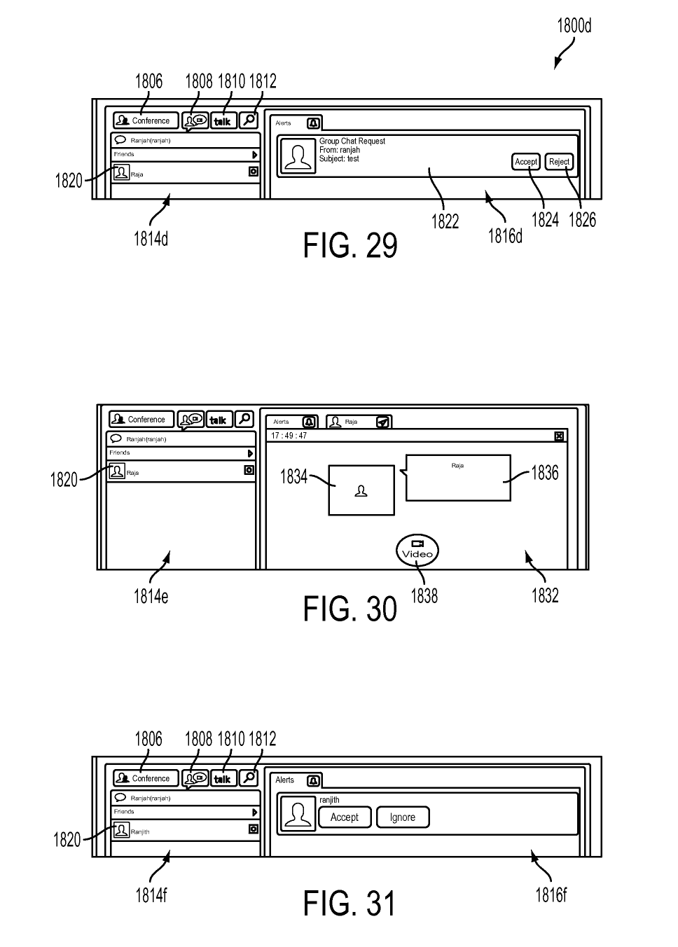

FIG. 29 illustrates one embodiment of the broadcast screen 1800d after receiving a chat request 1822 from one of the user's friends 1820. The chat request may comprise a one-on-one chat request or a group chat request. The chat request 1822 may comprise a video chat request, a text chat request, and/or an audio chat request. The chat request 1822 may comprise an accept button 1824 and a reject button 1826. If the user selects the accept button 1824, the integrated social media platform 2 dashboard may display a chat tab, for example, as shown in FIG. 30. FIG. 30 illustrates one embodiment of a broadcast interaction screen 1800e with a chat tab 1832 displayed. The chat tab 1832 may be displayed when a user initiates and/or accepts a chat request 1822 from another user. The chat tab 1832 may comprise an image 1834 selected by the friend, for example, an avatar or a profile picture of the friend. A chat box 1836 may provide messages and/or texts from the friend. A video button 1846 may initiate a video conference with the friend. Video chats may be initiated within the chat tab 1832 or may be initiated by a user by selecting a friend from the friend list and selecting a video chat option from the dashboard. FIG. 31 illustrates one embodiment of the broadcast screen 1800f receiving an alert 1840 that a friend has attempted to initiate a video conference or video chat with the user. An accept button 1842 and an ignore button 1844 may be displayed with the alert 1840 to allow a user to accept or ignore the request for video chat. If a user initiates and/or accepts a video chat request, the integrated social media platform 2 may display a video chat screen on the dashboard.

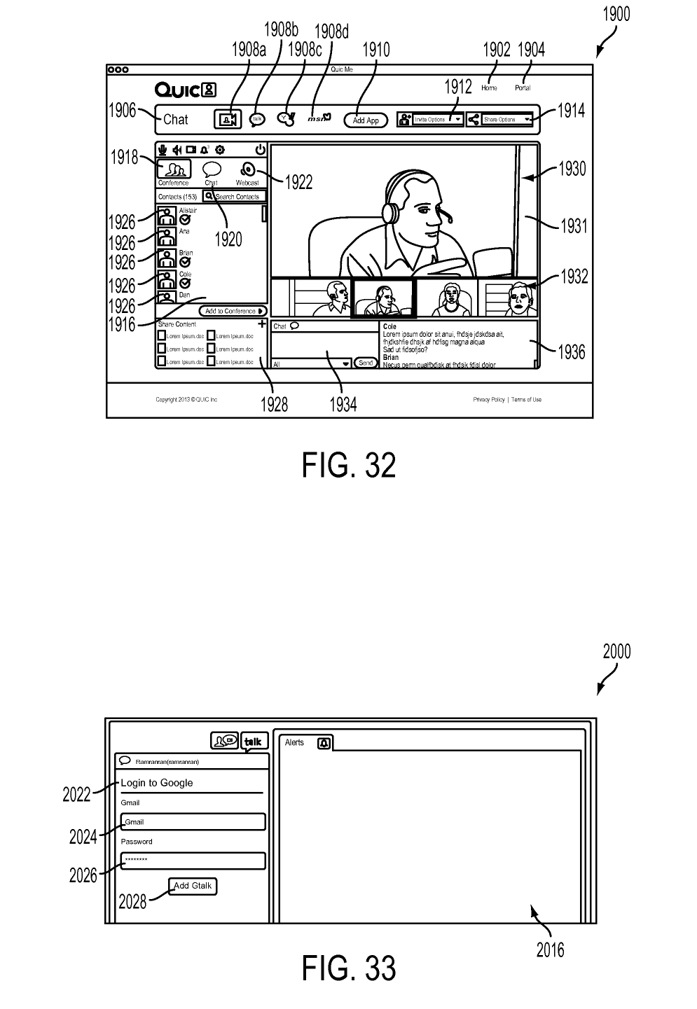

FIG. 32 illustrates one embodiment of a dashboard video chat screen 1900. The video chat screen 1900 may comprise a home button 1902 and a portal button 1904 similar to the home button 1202 and portal button 1204 discussed with respect to FIG. 20. The video chat screen 1900 may comprise a navigation bar 1906. The navigation bar 1906 may comprise one or more chat buttons, such as, for example, a video chat button 1908a, a Google Talk button 1908b, a Yahoo chat button 1908c, and/or a MSN chat button 1908d. The user may switch between chat types by selecting one or more of the buttons 1908a-1908d on the navigation bar. An add app button 1910 may allow a user to add one or more applications for chatting, such as, for example, video chat applications, desktop sharing applications, or shared workspace applications. The navigation bar 1906 may comprise an invite options button 1912 for controlling and inviting additional friends to a video chat and/or a sharing options button 1914 for sharing a video chat with users and non-users of the integrated social media platform 2, for example, by embedding a video chat within a user's social media identity page such that it may be viewed by any person connected to the web.

In some embodiments, the video chat screen 1900 may comprise a video chat panel 1916. The video chat panel may display a video chat and provide one or more options for controlling the video chat. The video chat panel 1916 may comprise a conference button 1918, a chat button 1920, and a webcast button 1922 for controlling the type of video chat. If the user selects the conference button 1916, the integrated social media platform 2 may provide one or more conference broadcast interactions, such as, for example, a shared content frame 1928, a text chat entry frame 1934, and/or a text chat display frame 1936. The conference button 1916 may provide one or more controls to a conference host. The host may be able to control, for example, which user is speaking, what video is displayed, and what content is shared during a conference. The video chat may be displayed in a video chat field 1930. In some embodiments, the video chat field may comprise a primary video 1931 and/or one or more secondary videos 1932. The secondary videos may comprise, for example, video chat feeds from ach of the conference participants. If a user selects the chat button 1920, the integrated social media platform 2 may provide a dashboard chat screen configured to provide video and text chatting without additional broadcast interactions. If the user selects the webcast button 1924, the integrated social media platform 2 may provide a dashboard chat screen that provides control to the user. In some embodiments, a webcast may only displays the content and/or video provided by the user. The webcast button 1924 may embed the video chat and other shared content in the user's social media identity page to share the webcast with one or more users or non-users of the integrated social media platform 2.

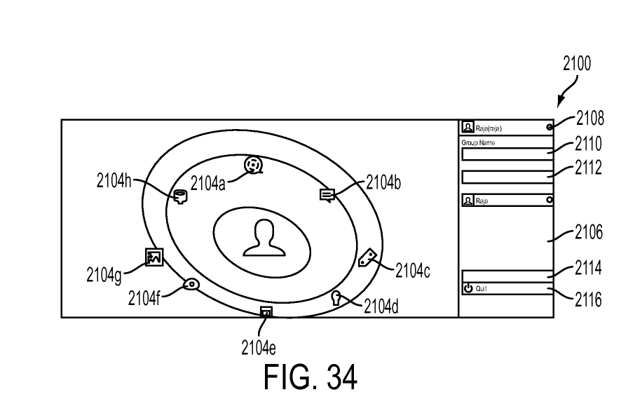

FIG. 33 illustrates one embodiment of a text chat screen 2000. The text chat screen 2000 may allow a user to login to one or more chat services. For example, in the illustrated embodiment, a user has selected the Google Talk button 2010 as the selected chat service. A login screen 2022 may prompt a user to enter a username 2024 and password 2026 to verify the user's Google Talk account. The user may submit the Google Talk credentials by selecting the “Add GTALK” button 2028. The integrated social media platform 2 may verify the user's Google Talk credentials and connect the user's Google Talk account to the integrated social media platform 2. FIG. 34 illustrates one embodiment of a dashboard conference setup screen 2100. The conference set up screen may comprise a broadcast interaction selection frame 2102. A user may select one or more broadcast interactions to enable during a conference from the broadcast interaction selection frame 2102. For example, a user may enable video sharing 2104a, text chat 2104b, scribbling 2104c, audio chatting 2104d, music sharing 2104e, Dropbox file sharing 2104f, image sharing 2104g, and/or desktop sharing 2104h. The conference setup screen 2100 may comprise a conference name field 2108. A user may enter a unique conference name into the conference name field 2108. A user may enter a subject or description for the conference into the subject field 2110. An online friends list 2112 allows a user to select which currently online friends should be invited to the conference. An enter room button 2114 may create the conference and display a conference screen, such as, for example, video chat screen 1900, to the user. An exit button 2116 may allow a user to exit the conference set up screen 2100.

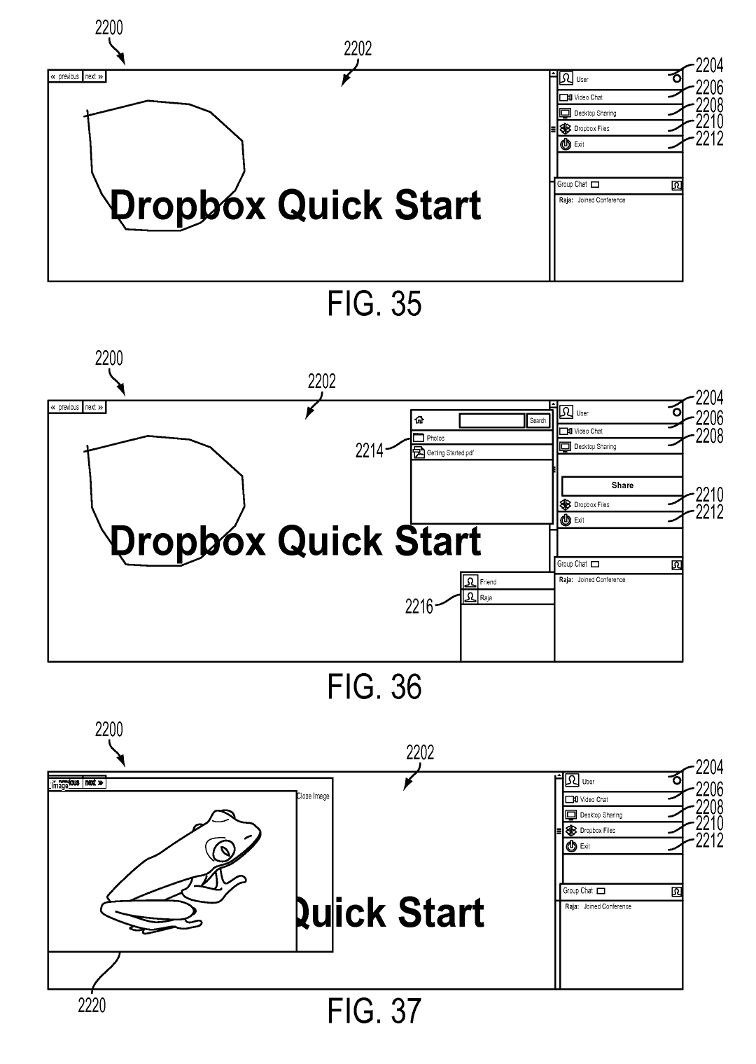

FIGS. 35-37 illustrate one embodiment of a dashboard conference screen 2200. The conference screen 2200 may comprise a content area 2202. In the illustrated embodiment, the content area 2202 may comprise a Dropbox quick start file. The Dropbox quick start file may be configured to allow scribbling and/or may display files stored in a Dropbox account. A broadcast interaction list 2204 may provide one or more broadcast interactions useable during the conference. For example, a video chat button 2206 may be used to initiate video chatting during the conference. A desktop sharing button 2208 may allow one or more users to share the user's desktop with other conference participants. A Dropbox files button 2210 may allow a user to share one or more files stored in a linked Dropbox account. An exit button 2212 may allow a user to exit the conference screen 2200. In FIG. 36, the user has selected the Dropbox sharing button 2210. A list 2214 of files and folders in the user's Dropbox account are displayed to the user. The user may select a file to share from the list 2214. A list of friends 2216 that have joined the conference may be displayed by the integrated social media platform 2 to allow a user to select specific friends to share the Dropbox file with. In FIG. 37, the user has selected a Dropbox file to share. The file 2220 is opened and displayed in the content area 2202 of the conference screen 2200 and shared with the selected conference participants.

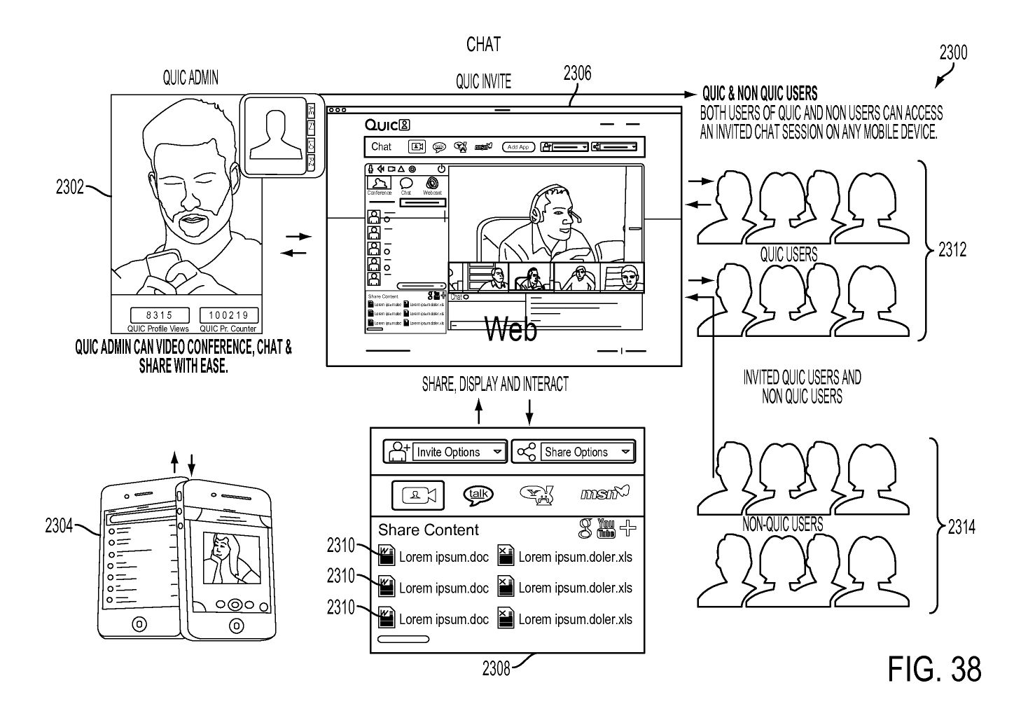

FIG. 38 illustrates one embodiment of a conference broadcast interaction 2300. An administrator 2302 may interact with the integrated social media platform 2 through a client device, such as, for example, a mobile device 2304. The administrator 2302 may access the dashboard through the client device. The administrator 2302 may invite one or more social media contacts, such as, for example, all of the administrator's 2302 social media contacts, and/or email or text contacts to join a video conference through a single dashboard interaction. The integrated social media platform 2 may transmit the invite to all of the selected contacts and may generate a dashboard conference screen 2306 for the conference. The conference screen 2306 may include a content sharing panel 2308 to allow the administrator to select one or more files 2310 for sharing during the video conference. The administrator 2302 may send invites to contacts comprising both users 2312 of the integrated social media platform 2 and non-users 2314 of the integrated social media platform 2. Non-users 2314 may be provided a link to access a temporary dashboard conference page generated by the integrated social media platform 2.

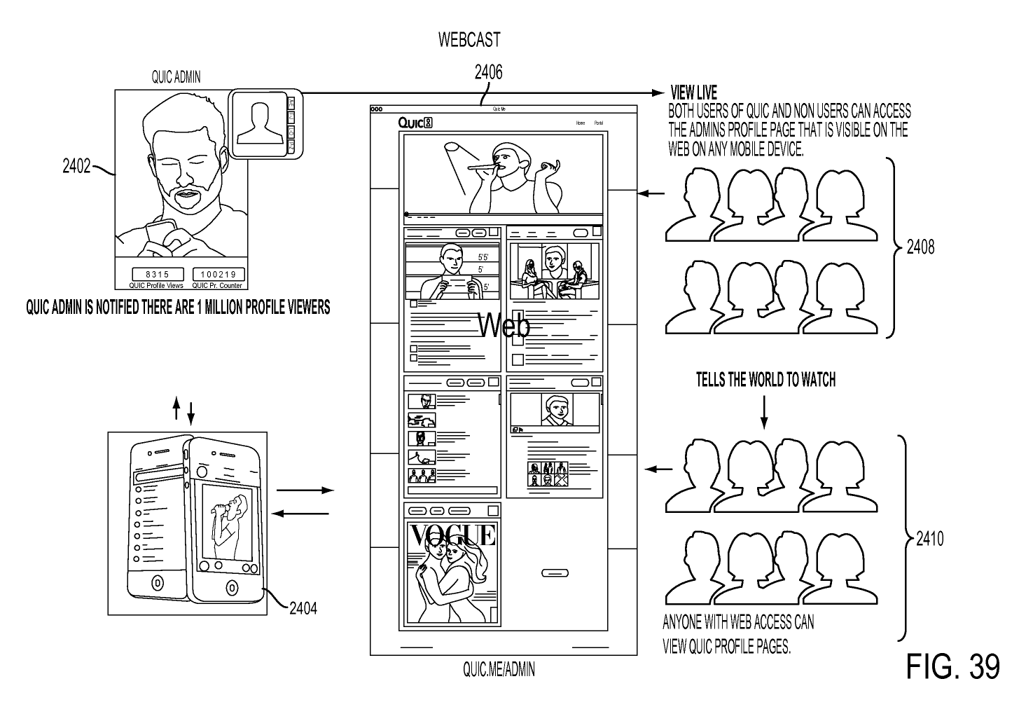

FIG. 39 illustrates one embodiment of a webcast 2400 using the integrated social media platform 2. An administrator 2402 may access the integrated social media platform 2 through a user device, such as, for example, by accessing the dashboard through a mobile device 2404. The administrator 2402 may receive a notification from the integrated social media platform 2 that the administrator 2402 currently has one million profile viewers. The notification may be sent to the user device using any suitable notification method, such as, for example, through a text message, e-mail message, and/or a chat message. The administrator 2402 may notify one or more of his social media and/or imported contacts, including email and text contacts, that the administrator 2402 will be conducting a webcast on the user's social media identity page. The administrator 2402 may notify all of the administrator's 2402 social media and/or imported contacts through a single interaction with the dashboard. The administrator 2402 may initiate a webcast. A webcast may comprise a video conference embedded on the user's social media identity page 2406. Both users 2408 and non-users 2410 of the integrated social media platform 2 may connect to the administrator's social media identity page 2406 to view the webcast. The webcast may comprise video, audio, text, or shared files. The frames of the administrator's 2402 social media identity page 2406 may comprise one or more frames corresponding to a video webcast ad/or other content shared by the administrator during the webcast.

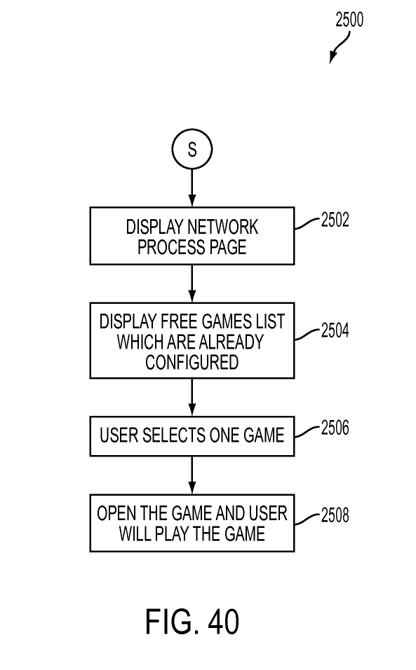

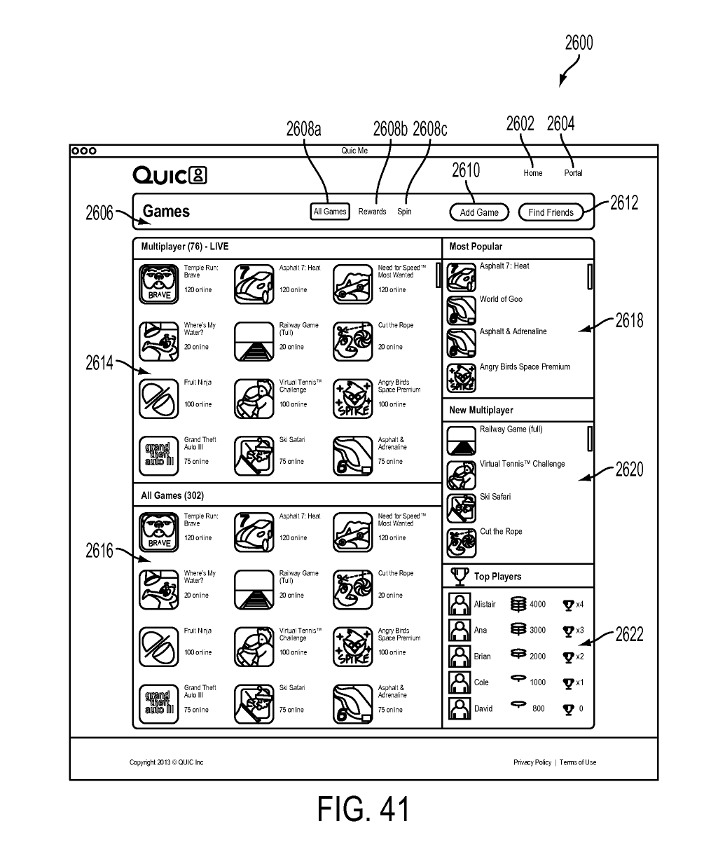

FIG. 40 illustrates one embodiment of an application selection process 2500. The integrated social media platform 2 may display 2502 a dashboard network process page to enable a user to engage in one or more network processes, such as, for example, the network processes described with respect to FIG. 4. A network process may comprise, for example, adding one or more applications to the integrated social media platform 2. The integrated social media platform 2 may display 2504 an application list, such as, for example, a list of games, either free or paid, a list of applications, and/or a list of widgets. A user may select 2506 one of the displayed applications, such as, for example, a game. The integrated social media platform 2 may open 2508 the game and may allow the user to play the game within the integrated social media platform 2. In some embodiments, the integrated social media platform 2 may add the game and/or statistics about the game to the user's social media identity page and/or the user's dashboard. FIG. 41 illustrates one embodiment of a dashboard games page 2600. The games page 2600 may comprise a home button 2602 and a portal button 2604 similar to the home button 1202 and the portal button 1204 discussed with respect to FIG. 20. A navigation bar 2606 may allow a user to select one or more network interactions. The navigation bar 2606 may comprise an “All games” button 2608a configured to display one or more games available to the user, a rewards button 2608b configured to display rewards earned by the user, and a spin button 2608c. An add game button 2610 may allow a user to add one or more games to the user's account, dashboard, and/or social media identity page. A find friends button 2612 may allow a user to find friends and identify what games and/or applications the user's friends are using. A list of multiplayer games 2614, a list of all games 1616, most popular games 2618, and new games 2620 may be displayed on the games page 2600. The games page 2600 may comprise a statistics frame 2622 configured to display statistics for one or more games and/or one or more users.

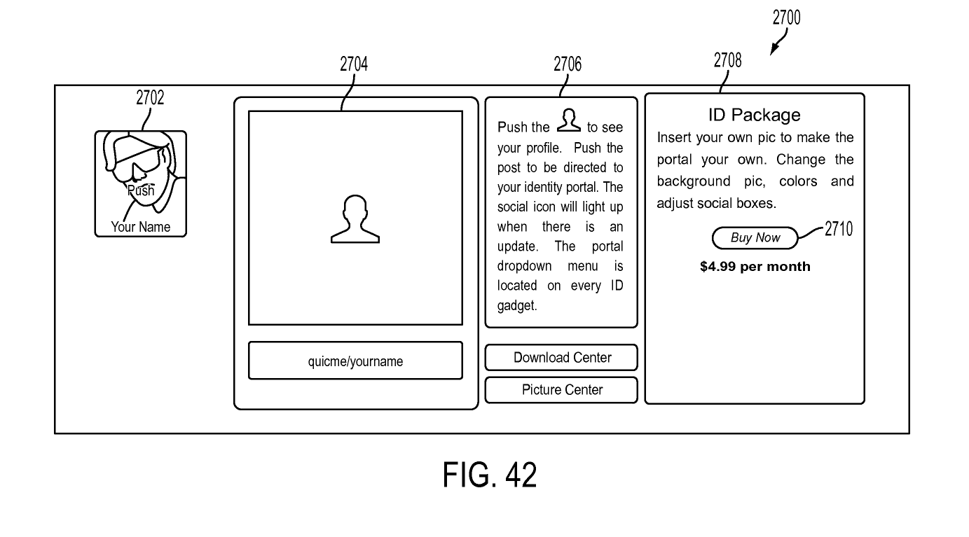

FIG. 42 illustrates one embodiment of a dashboard application purchase page 2700. The application purchase page may be presented to a user if the user selects a specific application, such as, for example, a content pack for the integrated social media platform 2. The application purchase page 2700 may comprise the user's profile picture 2702, a preview pane 2704 to preview the selection application, an instruction panel 2706, and a product description panel 2708. A purchase button 2710 may allow the user to purchase the selected application and/or widget. If the user selects the purchase button 2710, the integrated social media platform 2 may display a payment completion screen.

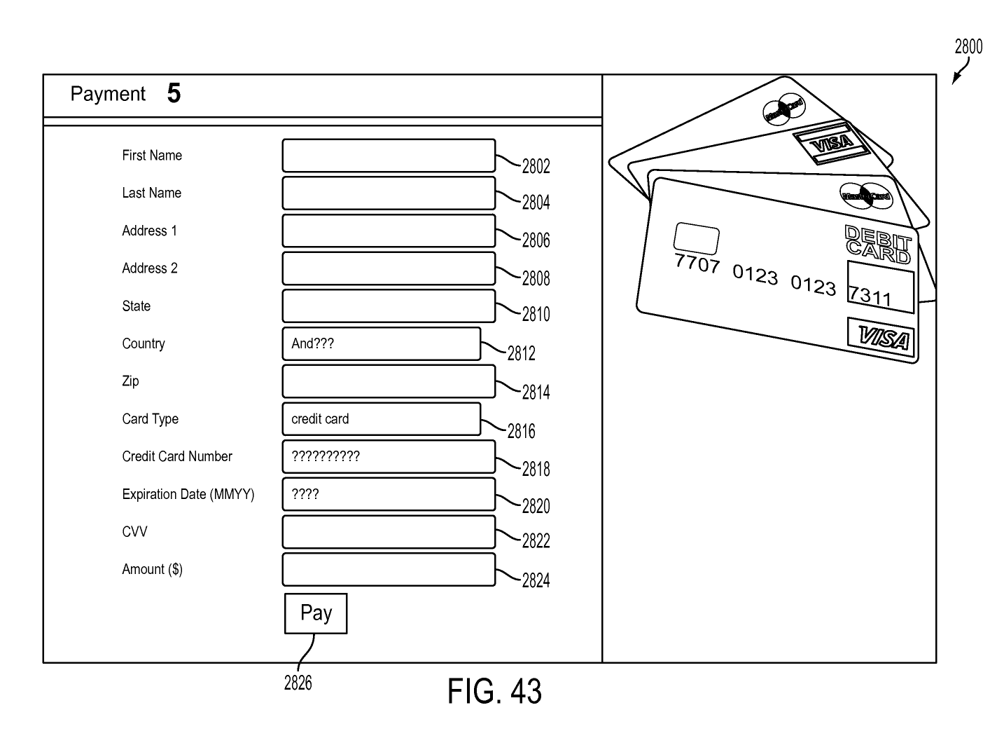

FIG. 43 illustrates a dashboard payment completion screen 2800. The payment completion screen 2800 may be configured to collect payment information from a user for completing one or more transactions through the integrated social media platform 2. The payment completion screen 2800 may comprise a first name field 2802 and a last name field 2804 for collecting the user's first and last name, a first address field 2806 and a second address field 2808 may be configured to receive the user's address screen, a state field 2810, a country field 2812, a zip code field 2814, a card type field 2816 for identifying the type of credit card the user is paying with, a credit card number field 2820, a credit card expiration date field, a credit card security code field 2822, and/or an amount field 2824. One or more of the fields of the payment completion screen may be automatically filled by the integrated social media platform 2 based on information provided by the user during the registration process. A pay button 2826 may submit the payment information for verification and charging of the user's credit card.

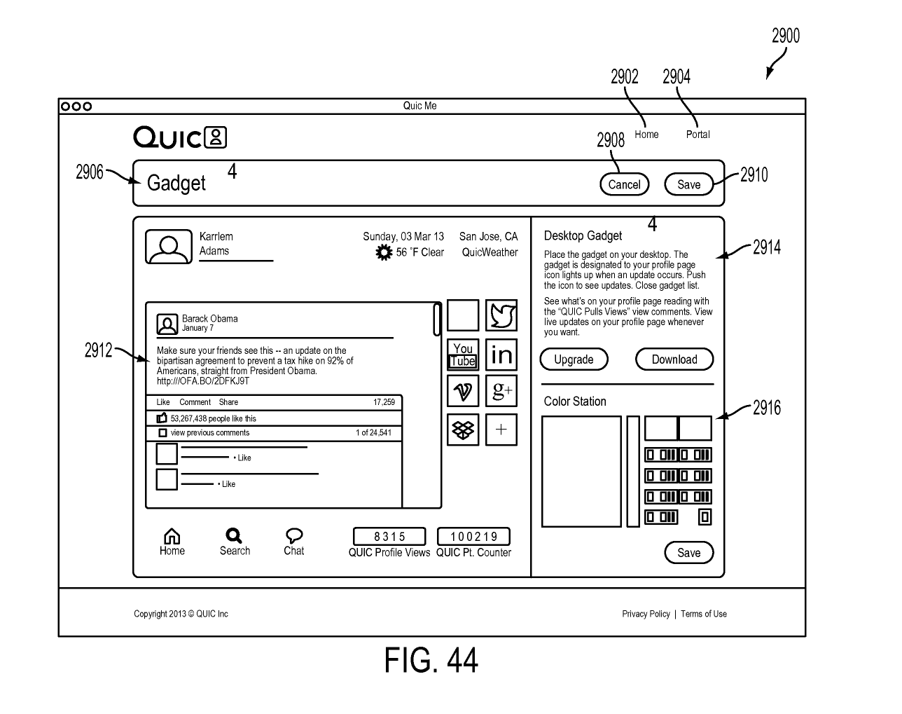

FIG. 44 illustrates one embodiment of a dashboard gadget screen 2900. The gadget screen 2900 may comprise a home button 2902 and a portal button 2904 similar to the home button 1202 and the portal button 1204 discussed with respect to FIG. 20. The gadget screen 2900 may be configured to allow a user to install, uninstall, modify, or download a selected widget/gadget. A navigation bar 2906 may comprise a cancel button 2908 and a save button 2910 for cancelling and/or saving changes made to the gadget settings on the gadget screen 2900. A gadget description pane 2912 may provide a description of the gadget and/or screen shots of the gadget. A gadget download frame 2914 may allow a user to download the gadget to the user's device. A gadget setting frame 2916 may allow a user to change one or more settings, such as, for example, color settings, for a selected gadget.

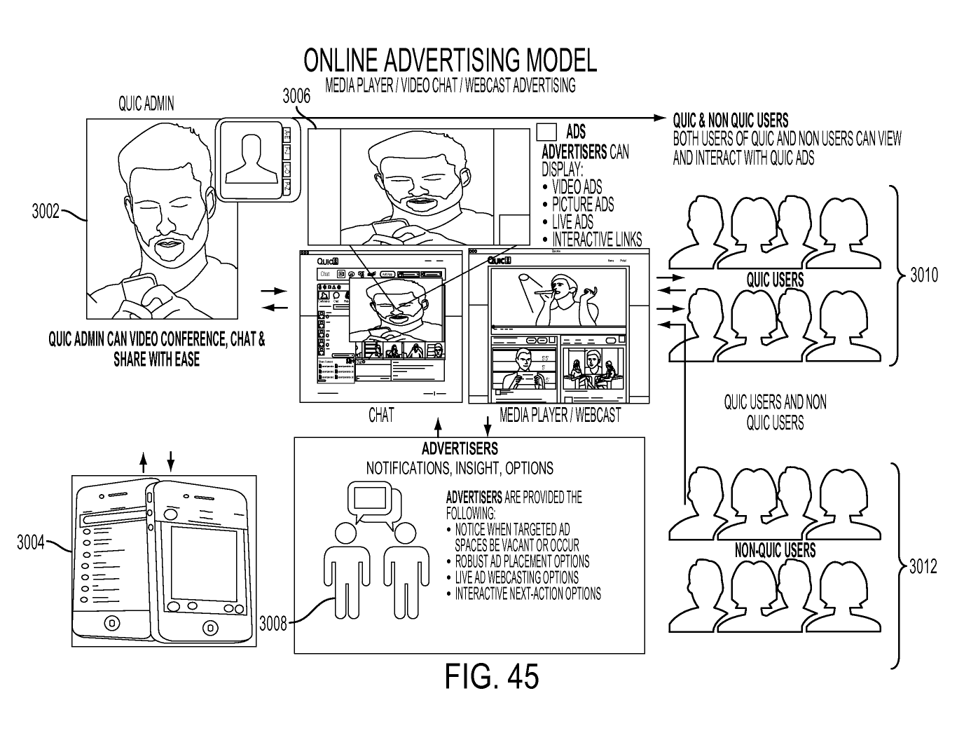

FIG. 45 illustrates one embodiment of an online advertising interaction 3000. An administrator 3002 may interact with the integrated social media platform 2 through one or more client devices, such as, for example, by accessing the dashboard on a mobile device 3004. The administrator 3002 may initiate a broadcast interaction with one or more social media contacts and/or imported contacts. For example, the administrator 3002 may invite one or more contacts to a webcast on the user's social media identity page 3006. One or more advertisers 3008 may purchase space on the user's social media identity page 3006 for placing advertisements.

Advertisements may be displayed, for example, during high traffic periods on the user's social media identity page 3006 or may always be displayed on a user's social media identity page 3006. The advertisers 3008 may be provided with notice when a targeted ad space is vacant and/or when a targeted ad occurs. The advertisers 3008 may be presented with robust advertisement placement options for placing ads on a user's social media identity page 3006 and may have live ad webcasting options or interactive next-action options. In some embodiments, advertisers 3008 may instantly place ads on the user's social media identity page during heavy traffic broadcast interactions. Advertisers 3008 may be provided with one or more options on the advertiser's dashboard. Ads may be placed and/or managed seamlessly within the integrated social media platform 2. When users 3010 or non-users 3012 of the integrated social media platform 2 view the user's social media identity page 3006, the users 3010 and/or non-users 3012 are presented with ads provided by the advertisers 3008.

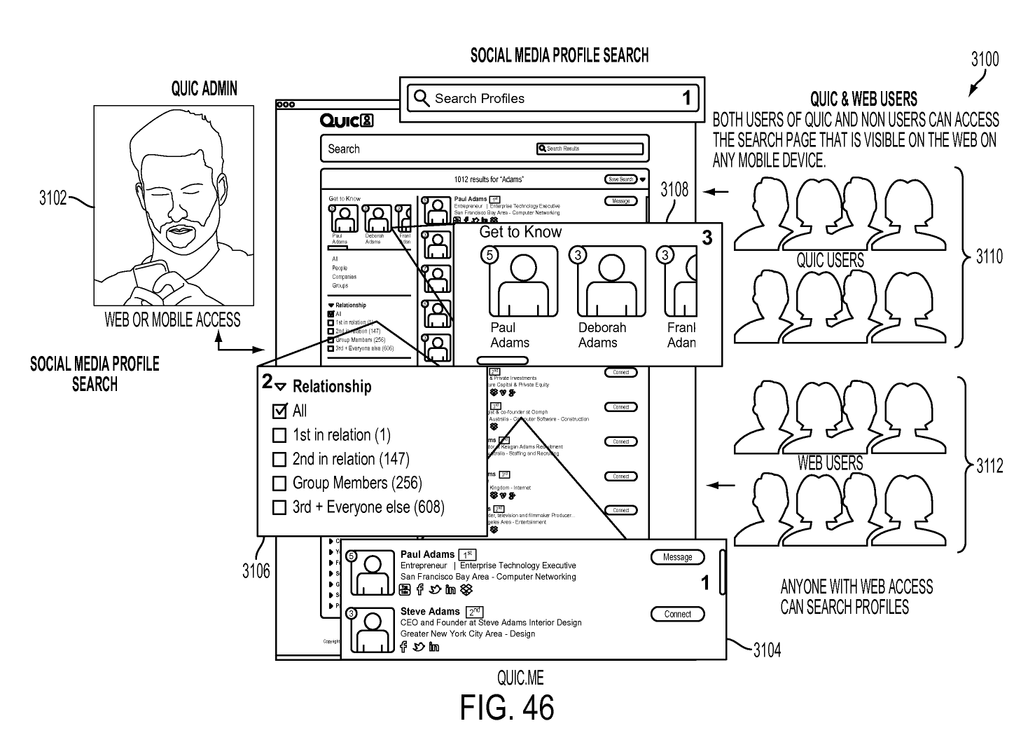

In some embodiments, a user may be able to conduct a social media search. FIG. 46 illustrates one embodiment of a social media search interaction 3100. A user, such as, for example, an administrator 3102, may conduct a search of one or more additional users of the integrated social media platform 2 and/or of one or more linked social media networks. For example, in one embodiment, an administrator 3102 may use a search page 3104 to search for one or more users of the integrated social media platform 2. The administrator 3102 may select one or more results from a results pane 3108. A relationship frame 3114 may identify the relationships between the administrator 3102 and the selected user, for example, by showing shared friends, contacts, or content. The administrator 3102 may be able to send a friend request to the identified user through the integrated social media platform 2 and/or one or more of the linked social networks. Users 3110 and non-users 3112 may access the search page 3104 for searching users of the integrated social media platform 2.

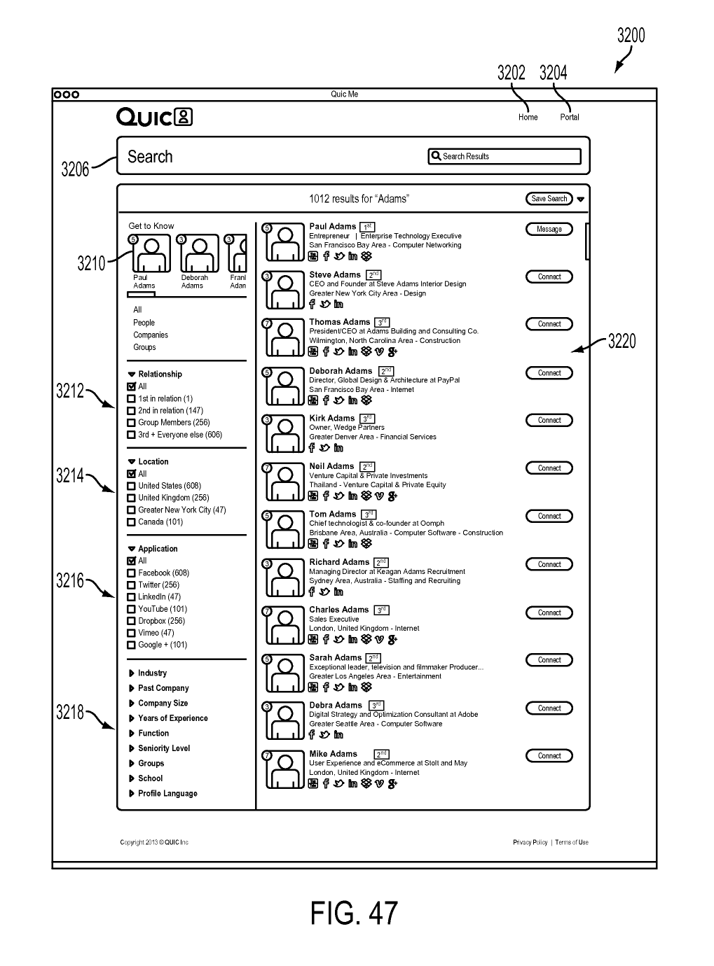

FIG. 47 illustrates one embodiment of a dashboard search results page 3200. The search results page 3200 may comprise home button 3202 and a portal button 3204 similar to the home button 1202 and the portal button 1204 discussed with respect to FIG. 20. A search navigation bar 3206 may comprise a search box 3208. A user may enter a name in the search box 3208 to search for one or more profiles matching the entered name. A search results list 3220 may display a list of all profiles/users matching the search criteria. A “Get-to-Know” frame 3210 may allow a user to obtain additional information about a selected profile/user. A relationship frame 3212 may allow a user to filter the search results by limiting the results to only profiles having a specific type of relationship with the user. A location frame 3214 may limit the search results by location. An application frame 3216 may limit the search results to a specific application, such as, for example, by limiting the search results to a specific social media network. An additional limitations frame 3218 may allow a user to select one or more additional filters for the search results displayed in the search results frame 3220.

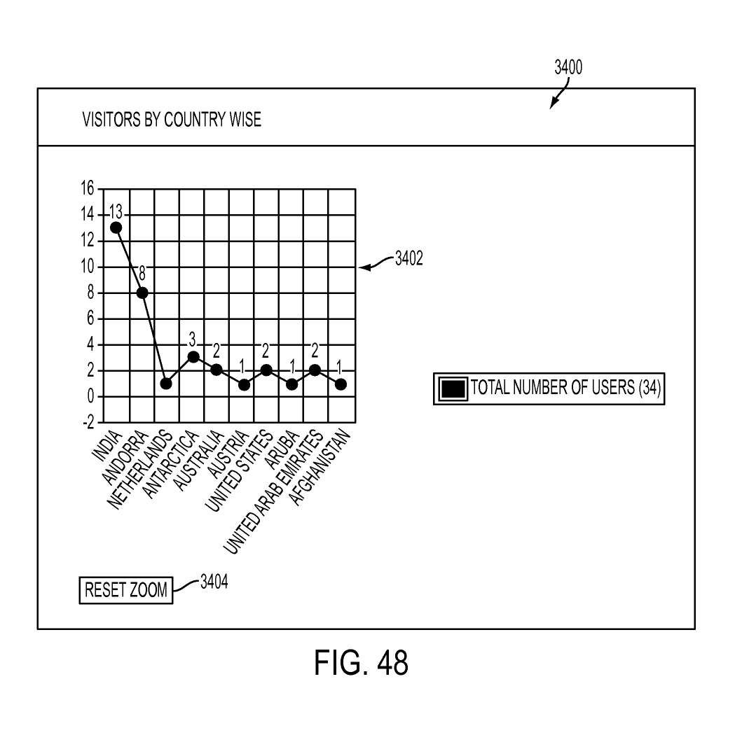

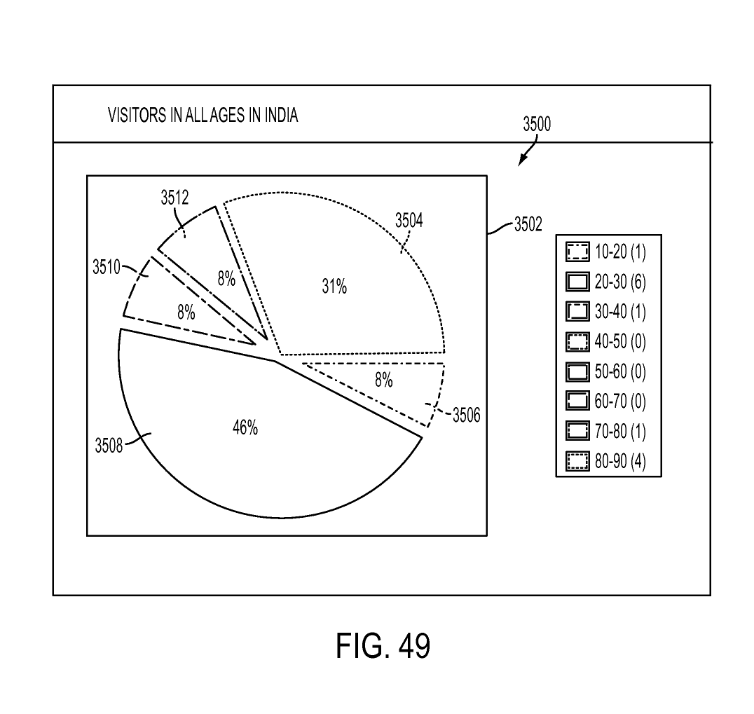

FIGS. 48-51 illustrate various dashboard analytical screens that may be generated by the integrated social media platform 2. As illustrated in FIG. 5, a user, such as an administrator 99, may interact with the integrated social media platform 2 to display analytical data, such as, for example, analytical charts 100, on the dashboard. FIG. 48 illustrates one embodiment of a visitors dashboard analytics page 3400 configured by country. The visitors by country dashboard analytics page 3400 may comprise an analytic chart 3402 configured to display the number visitors who have viewed the user's social media identity page versus the country in which each visitor resides. The user may manipulate the chart 3400, such as, for example, by zooming in on the chart. A reset zoom button 3404 may reset the chart view to a default state. FIG. 49 illustrates one embodiment of a visitors dashboard analytics page 3500 configured by age. The visitors by age dashboard analytics page 3500 may comprise an analytics chart 3502 configured to display the number of visitors to the user's social media identity page broken down into discrete age ranges. The identified sections of the pie chart 3504-3512 correspond to each of the discrete age ranges tracked by the integrated social media platform 2.

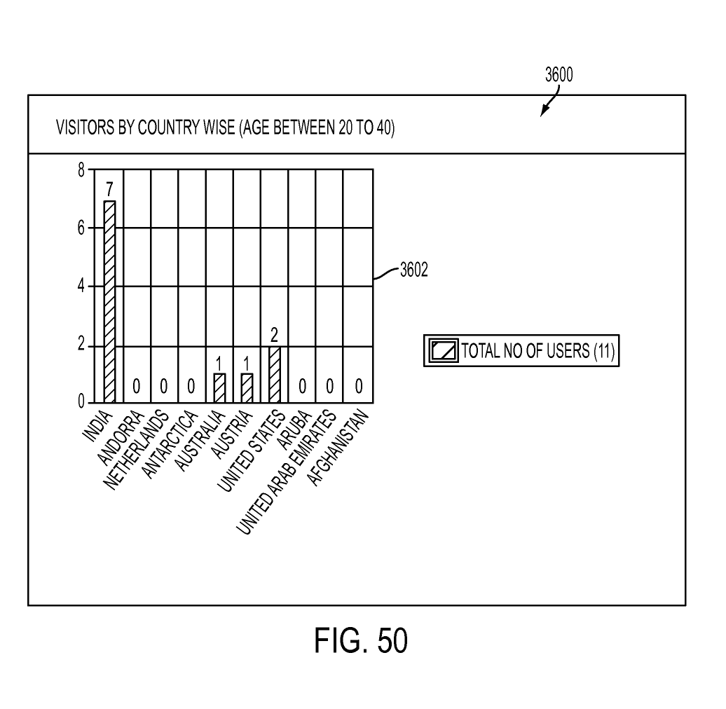

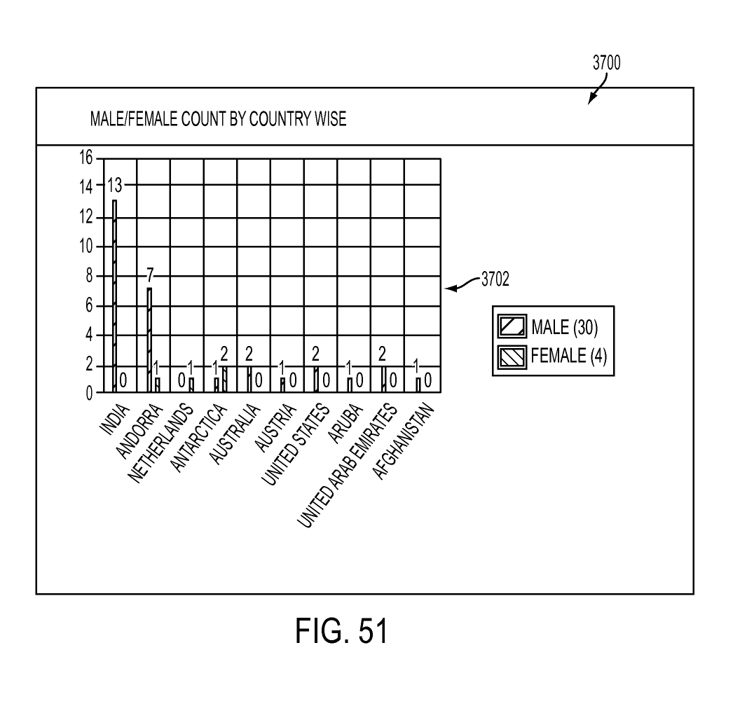

FIG. 50 illustrates one embodiment of a visitors dashboard analytics page 3600 configured by country within a specific age range. The visitors by country within a specific range dashboard analytics page 3600 illustrates the number of visitors within a selected age range, such as, for example, 20 to 40 years old, plotted against the country in which the visitors reside. FIG. 51 illustrates one embodiment of a demographic dashboard analytics page 3700 comprising an analytics chart 2702 illustrating the number of visitors that are male or female from each of the identified countries. The analytical data provided by the integrated social media platform 2 may be used by users, administrators, and/or advertisers to focus social media content, campaigns, and advertisements at specific demographic groups most likely to visit the user's social media identity page.

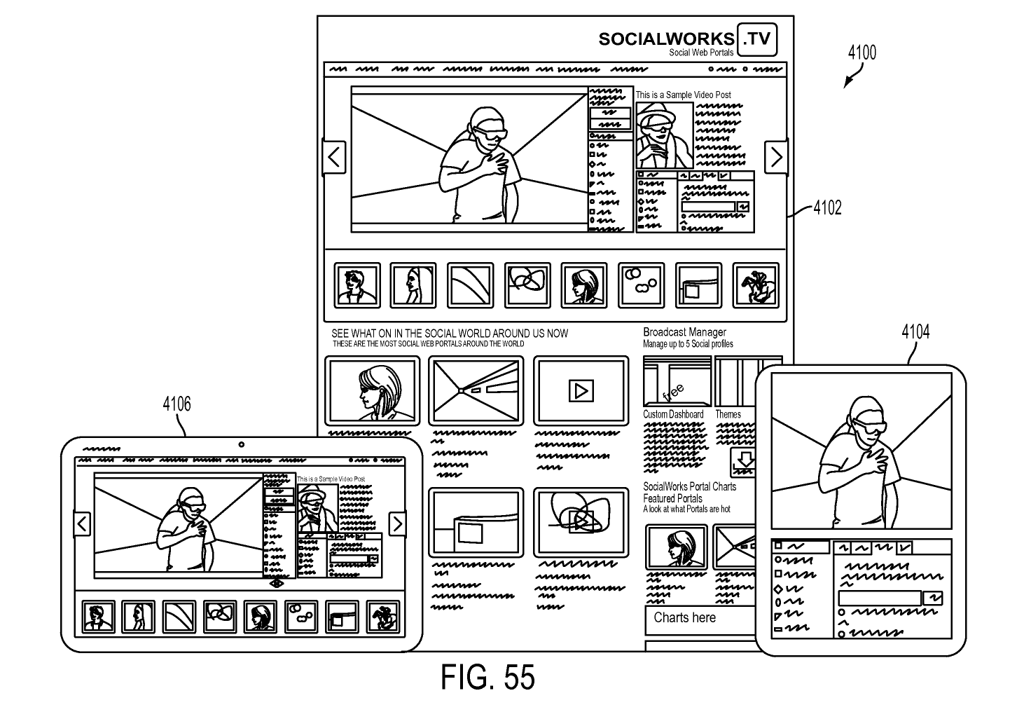

FIG. 55 illustrates one embodiment of a social media identity page 4100. The social media identity page 4100 may be provided by the integrated social media platform 2 to the user through one or more user devices, such as, for example, a mobile user device 4104. The social media identity page 4100 may be modified based on the type of client device accessing the integrated social media platform 2. For example, a second mobile user device 4106 may receive a modified social media identity page based on the requirements of the second mobile user device 4106.

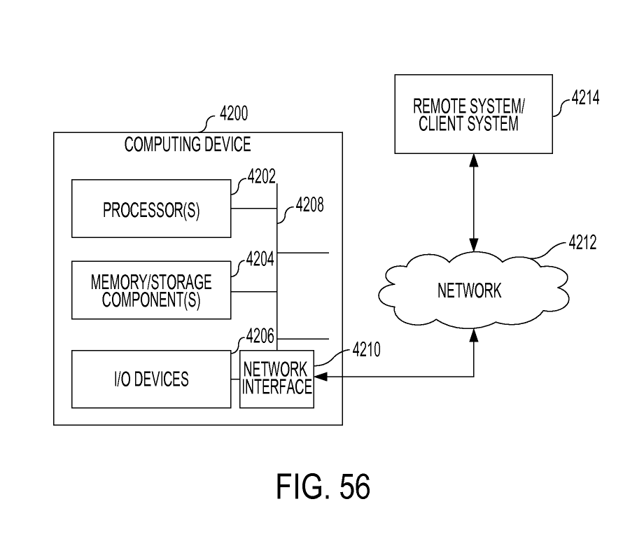

FIG. 56 illustrates one embodiment of a computing device 4200 which can be used in one embodiment of the system and method for providing an integrated social media platform. For the sake of clarity, the computing device 4200 is shown and described here in the context of a single computing device. It is to be appreciated and understood, however, that any number of suitably configured computing devices can be used to implement any of the described embodiments. For example, in at least some implementation, multiple communicatively linked computing devices are used. One or more of these devices can be communicatively linked in any suitable way such as via one or more networks (LANs), one or more wide area networks (WANs) or any combination thereof.

In this example, the computing device 4200 comprises one or more processor circuits or processing units 4202, on or more memory circuits and/or storage circuit component(s) 4204 and one or more input/output (I/O) circuit devices 4206. Additionally, the computing device 4200 comprises a bus 4208 that allows the various circuit components and devices to communicate with one another. The bus 4208 represents one or more of any of several types of bus structures, including a memory bus or local bus using any of a variety of bus architectures. The bus 4208 may comprise wired and/or wireless buses.

The processing unit 4202 may be responsible for executing various software programs such as system programs, applications programs, and/or module to provide computing and processing operations for the computing device 4200. The processing unit 4202 may be responsible for performing various voice and data communications operations for the computing device 4200 such as transmitting and receiving voice and data information over one or more wired or wireless communication channels. Although the processing unit 4202 of the computing device 4200 includes single processor architecture as shown, it may be appreciated that the computing device 4200 may use any suitable processor architecture and/or any suitable number of processors in accordance with the described embodiments. In one embodiment, the processing unit 4200 may be implemented using a single integrated processor.

The processing unit 4202 may be implemented as a host central processing unit (CPU) using any suitable processor circuit or logic device (circuit), such as a as a general-purpose processor. The processing unit 4202 also may be implemented as a chip multiprocessor (CMP), dedicated processor, embedded processor, media processor, input/output (I/O) processor, co-processor, microprocessor, controller, microcontroller, application specific integrated circuit (ASIC), field programmable gate array (FPGA), programmable logic device (PLD), or other processing device in accordance with the described embodiments.

As shown, the processing unit 4202 may be coupled to the memory and/or storage component(s) 4204 through the bus 4208. The memory bus 4208 may comprise any suitable interface and/or bus architecture for allowing the processing unit 4202 to access the memory and/or storage component(s) 4204. Although the memory and/or storage component(s) 4204 may be shown as being separate from the processing unit 4202 for purposes of illustration, it is worthy to note that in various embodiments some portion or the entire memory and/or storage component(s) 4204 may be included on the same integrated circuit as the processing unit 4202. Alternatively, some portion or the entire memory and/or storage component(s) 4204 may be disposed on an integrated circuit or other medium (e.g., hard disk drive) external to the integrated circuit of the processing unit 4202. In various embodiments, the computing device 4200 may comprise an expansion slot to support a multimedia and/or memory card, for example.

The memory and/or storage component(s) 4204 represent one or more computer-readable media. In some embodiments, the computer-readable media may comprise non-transitory computer readable-media. The memory and/or storage component(s) 4204 may be implemented using any computer-readable media capable of storing data such as volatile or non-volatile memory, removable or non-removable memory, erasable or non-erasable memory, writeable or re-writeable memory, and so forth. The memory and/or storage component(s) 304 may comprise volatile media (e.g., random access memory (RAM)) and/or nonvolatile media (e.g., read only memory (ROM), Flash memory, optical disks, magnetic disks and the like). The memory and/or storage component(s) 4204 may comprise fixed media (e.g., RAM, ROM, a fixed hard drive, etc.) as well as removable media (e.g., a Flash memory drive, a removable hard drive, an optical disk, etc.). Examples of computer-readable storage media may include, without limitation, RAM, dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information.

The one or more I/O devices 4206 allow a user to enter commands and information to the computing device 4200, and also allow information to be presented to the user and/or other components or devices. Examples of input devices include a keyboard, a cursor control device (e.g., a mouse), a microphone, a scanner, biometric sensors, and the like. Examples of output devices include a display device (e.g., a monitor or projector, speakers, a printer, a network card, etc.). The computing device 4200 may comprise an alphanumeric keypad coupled to the processing unit 4202. The keypad may comprise, for example, a QWERTY key layout and an integrated number dial pad. The computing device 4200 may comprise a display coupled to the processing unit 4202. The display may comprise any suitable visual interface for displaying content to a user of the computing device 4200. In one embodiment, for example, the display may be implemented by a liquid crystal display (LCD) such as a touch-sensitive color (e.g., 76-bit color) thin-film transistor (TFT) LCD screen. The touch-sensitive LCD may be used with a stylus and/or a handwriting recognizer program.

The processing unit 4202 may be arranged to provide processing or computing resources to the computing device 4200. For example, the processing unit 4202 may be responsible for executing various software programs including system programs such as operating system (OS) and application programs. System programs generally may assist in the running of the computing device 4200 and may be directly responsible for controlling, integrating, and managing the individual hardware components of the computer system. The OS may be implemented, for example, as a Microsoft® Windows OS, Symbian OS™, Embedix OS, Linux OS, Binary Run-time Environment for Wireless (BREW) OS, JavaOS, Android OS, Apple OS or other suitable OS in accordance with the described embodiments. The computing device 4200 may comprise other system programs such as device drivers, programming tools, utility programs, software libraries, application programming interfaces (APIs), and so forth.

The computer 4200 also includes a network interface 4210 coupled to the bus 4208. The network interface 4210 provides a two-way data communication coupling to a local network 4212. For example, the network interface 4210 may be a digital subscriber line (DSL) modem, satellite dish, an integrated services digital network (ISDN) card or other data communication connection to a corresponding type of telephone line. As another example, the communication interface 4210 may be a local area network (LAN) card effecting a data communication connection to a compatible LAN. Wireless communication means such as internal or external wireless modems may also be implemented.

In any such implementation, the network interface 4210 sends and receives electrical, electromagnetic or optical signals that carry digital data streams representing various types of information, such as the selection of goods to be purchased, the information for payment of the purchase, or the address for delivery of the goods. The network interface 4210 typically provides data communication through one or more networks to other data devices. For example, the network interface 4210 may effect a connection through the local network to an Internet Host Provider (ISP) or to data equipment operated by an ISP. The ISP in turn provides data communication services through the internet (or other packet-based wide area network). The local network and the internet both use electrical, electromagnetic or optical signals that carry digital data streams. The signals through the various networks and the signals on the network interface 4210, which carry the digital data to and from the computer system 4200, are exemplary forms of carrier waves transporting the information.

The computer 4200 can send messages and receive data, including program code, through the network(s) and the network interface 4210. In the Internet example, a server might transmit a requested code for an application program through the internet, the ISP, the local network (the network 4212) and the network interface 4210. In accordance with the present disclosure, one such downloaded application provides for the identification and analysis of a prospect pool and analysis of marketing metrics. The received code may be executed by processor 4214 as it is received, and/or stored in storage device 4210, or other non-volatile storage for later execution. In this manner, computer 4200 may obtain application code in the form of a carrier wave.

In some embodiments, a remote system 4214 may be in communication with the computer 4200 in a client-server configuration. For example, in one embodiment, the remote system 4214 may comprise a client device and the computer 4200 may comprise a server. A server may comprise a computer 4200 that selectively shares its resources with one or more clients. A client may comprise a remote device 4214 that initiates contact with the server in order to make use of the server's resources. In some embodiments, resources of the server may comprise data, program, processors, peripheral devices, and/or storage device, to name just a few. In some embodiments, the client and server may communicate in a request-response messaging pattern, for example, the client may send a request to the server and the server may send a response. The computer 4200 may be configured as any suitable server, for example, an application server, a catalog server, a communications server, a database server, a file server, a game server, a home server, a proxy server, a stand-alone server, and/or a web server. The client device 4214 may comprise any suitable computing device, such as, for example, a desktop computer, a mobile device, and/or a second server.

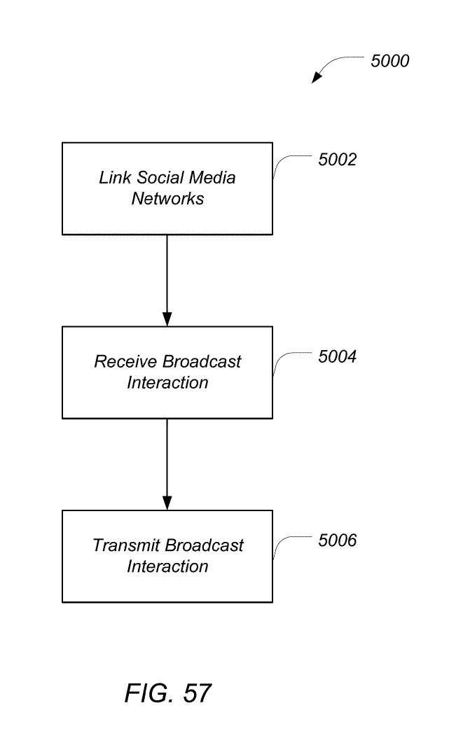

FIG. 57 illustrates one embodiment of a computer-implemented method 5000 that can be executed by the computing device 4200 and more specifically by the one or more processor circuits or processing units 4202 of the computing device 4200. In one embodiment of the computer-implemented method 5000, the processor 4202 links 5002 at least a first social media network 6a-6f and a second social media network 6a-6f in an integrated social media platform 2. The processor 4202 receives 5004 a broadcast interaction from a user. The broadcast interaction comprises an interaction between the user and one or more contacts associated with at least one of the first social media network 6a-6f or the second social media network 6a-6f. The processor 4202 transmits 5006 a notification of the broadcast interaction to at least one of the first social media network 6a-6f and the second social media network 6a-6f.

In some embodiments of the computer-implemented method 5000, the processor 4202 transmits the broadcast interaction to at least one of the first social media network 6a-6f and the second social media network 6a-6f.

In some embodiments of the computer-implemented method 5000, the processor 4202 generates an integrated social media identity. The integrated social media identity comprises content from the first social media network 6a-6f and content from the second social media network 6a-6f. The processor 4202 provides the integrated social media identity to one or more client devices, for example, client device 1606. Further, the processor 4202 receives a webcast broadcast interaction comprising a live webcast hosted by the user, notifies one or more contacts about the webcast broadcast interaction, and embeds the live webcast in the user's integrated social media identity. In addition, the processor 4202 provides the integrated social media identity to one or more client devices 1606 comprising additional users of the integrated social media platform. The processor 4202 also provides the integrated social media page to one or more requestors comprising non-users of the integrated social media platform 2.

In some embodiments of the computer-implemented method 5000, the processor 4202 receives a chat broadcast interaction from the user. The chat broadcast interaction comprises a request to one or more contacts to initiate a chat session with the user. The processor 4202 transmits a chat notification to the one or more contacts. The processor 4202 initiates a chat session between the one or more contacts and the user. Further, the processor 4202 receives the chat broadcast interaction comprising a video chat request and initiates a video chat session between the one or more contacts and the user.

In some embodiments of the computer-implemented method 5000 the processor 4202 receives an update broadcast interaction comprising an update for the first social media network. The processor 4202 transmits the update broadcast interaction to the first social media network 6a-6f. The processor 4202 transmits the notification to one or more contacts regarding the update broadcast interaction. The one or more contacts are associated with the second social media network 6a-6f.

In various embodiments, the computer-implemented method 5000 may be stored in a non-transitory computer-readable storage medium in the form of executable program instructions embodied thereon such that they can be executed by the processor 4202 of the computing device 4200 implemented as a server.

Various embodiments may be described herein in the general context of computer executable instructions, such as software, program modules, and/or engines being executed by a computer. Generally, software, program modules, and/or engines include any software element arranged to perform particular operations or implement particular abstract data types. Software, program modules, and/or engines can include routines, programs, objects, components, data structures and the like that perform particular tasks or implement particular abstract data types. An implementation of the software, program modules, and/or engines components and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices that are linked through a communications network. In a distributed computing environment, software, program modules, and/or engines may be located in both local and remote computer storage media including memory storage devices.

Although some embodiments may be illustrated and described as comprising functional components, software, engines, and/or modules performing various operations, it can be appreciated that such components or modules may be implemented by one or more hardware components, software components, and/or combination thereof. The functional components, software, engines, and/or modules may be implemented, for example, by logic (e.g., instructions, data, and/or code) to be executed by a logic device (e.g., processor). Such logic may be stored internally or externally to a logic device on one or more types of computer-readable storage media. In other embodiments, the functional components such as software, engines, and/or modules may be implemented by hardware elements that may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Examples of software, engines, and/or modules may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some cases, various embodiments may be implemented as an article of manufacture. The article of manufacture may include a computer readable storage medium arranged to store logic, instructions and/or data for performing various operations of one or more embodiments. In various embodiments, for example, the article of manufacture may comprise a magnetic disk, optical disk, flash memory or firmware containing computer program instructions suitable for execution by a general purpose processor or application specific processor. The embodiments, however, are not limited in this context.

The functions of the various functional elements, logical blocks, modules, and circuits elements described in connection with the embodiments disclosed herein may be implemented in the general context of computer executable instructions, such as software, control modules, logic, and/or logic modules executed by the processing unit. Generally, software, control modules, logic, and/or logic modules comprise any software element arranged to perform particular operations. Software, control modules, logic, and/or logic modules can comprise routines, programs, objects, components, data structures and the like that perform particular tasks or implement particular abstract data types. An implementation of the software, control modules, logic, and/or logic modules and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices that are linked through a communications network. In a distributed computing environment, software, control modules, logic, and/or logic modules may be located in both local and remote computer storage media including memory storage devices.

Additionally, it is to be appreciated that the embodiments described herein illustrate example implementations, and that the functional elements, logical blocks, modules, and circuits elements may be implemented in various other ways which are consistent with the described embodiments. Furthermore, the operations performed by such functional elements, logical blocks, modules, and circuits elements may be combined and/or separated for a given implementation and may be performed by a greater number or fewer number of components or modules. As will be apparent to those of skill in the art upon reading the present disclosure, each of the individual embodiments described and illustrated herein has discrete components and features which may be readily separated from or combined with the features of any of the other several aspects without departing from the scope of the present disclosure. Any recited method can be carried out in the order of events recited or in any other order which is logically possible.

It is worthy to note that any reference to “one embodiment” or “an embodiment” means that a particular feature, structure, or characteristic described in connection with the embodiment is comprised in at least one embodiment. The appearances of the phrase “in one embodiment” or “in one aspect” in the specification are not necessarily all referring to the same embodiment.

Unless specifically stated otherwise, it may be appreciated that terms such as “processing,” “computing,” “calculating,” “determining,” or the like, refer to the action and/or processes of a computer or computing system, or similar electronic computing device, such as a general purpose processor, a DSP, ASIC, FPGA or other programmable logic device, discrete gate or transistor logic, discrete hardware components, or any combination thereof designed to perform the functions described herein that manipulates and/or transforms data represented as physical quantities (e.g., electronic) within registers and/or memories into other data similarly represented as physical quantities within the memories, registers or other such information storage, transmission or display devices.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, also may mean that two or more elements are not in direct contact with each other, but yet still co-operate or interact with each other. With respect to software elements, for example, the term “coupled” may refer to interfaces, message interfaces, application program interface (API), exchanging messages, and so forth.

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits ASICs, FPGAs, DSPs, or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, non-transitory medium, transmitting computer, receiving computer, etc. located outside the territory).

Although various embodiments have been described herein, many modifications, variations, substitutions, changes, and equivalents to those embodiments may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed embodiments. The following claims are intended to cover all such modification and variations.

In summary, numerous benefits have been described which result from employing the concepts described herein. The foregoing description of the one or more embodiments has been presented for purposes of illustration and description. It is not intended to be exhaustive or limiting to the precise form disclosed. Modifications or variations are possible in light of the above teachings. The one or more embodiments were chosen and described in order to illustrate principles and practical application to thereby enable one of ordinary skill in the art to utilize the various embodiments and with various modifications as are suited to the particular use contemplated. It is intended that the claims submitted herewith define the overall scope.

Various aspects of the subject matter described herein are set out in the following numbered clauses:

1. A computer-implemented method executed by a server, the method comprising: linking, by a processor, at least a first social media network and a second social media network in an integrated social media platform; receiving, by the processor, a broadcast interaction from a user, wherein the broadcast interaction comprises an interaction between the user and one or more contacts associated with at least one of the first social media network or the second social media network; and transmitting, by the processor, a notification of the broadcast interaction to at least one of the first social media network and the second social media network.

2. The computer-implemented method of clause 1, comprising transmitting, by the processor, the broadcast interaction to at least one of the first social media network and the second social media network.

3. The computer-implemented method of clause 1, comprising: generating, by the processor, an integrated social media identity, wherein the integrated social media identity comprises content from the first social media network and content from the second social media network; and providing, by the processor, the integrated social media identity to one or more client devices.

4. The computer-implemented method of clause 3, comprising: receiving, by the processor, a webcast broadcast interaction comprising a live webcast hosted by the user; notifying, by the processor, one or more contacts about the webcast broadcast interaction; and embedding, by the processor, the live webcast in the user's integrated social media identity.

5. The computer-implemented method of clause 3, comprising providing, by the processor, the integrated social media identity to one or more client devices comprising additional users of the integrated social media platform.

6. The computer-implemented method of clause 3, comprising providing, by the processor, the integrated social media page to one or more requestors comprising non-users of the integrated social media platform.

7. The computer-implemented method of clause 1, comprising: receiving, by the processor, a chat broadcast interaction from the user, wherein the chat broadcast interaction comprises a request to one or more contacts to initiate a chat session with the user; transmitting, by the processor, a chat notification to the one or more contacts; and initiating, by the processor, a chat session between the one or more contacts and the user.

8. The computer-implemented method of clause 7, comprising: receiving, by the processor, the chat broadcast interaction comprising a video chat request; and initiating, by the processor, a video chat session between the one or more contacts and the user.

9. The computer-implemented method of clause 1, comprising: receiving, by the processor, an update broadcast interaction comprising an update for the first social media network; transmitting, by the processor, the update broadcast interaction to the first social media network; and transmitting, by the processor, the notification to one or more contacts regarding the update broadcast interaction, wherein the one or more contacts are associated with the second social media network.

10. A non-transitory computer-readable storage medium having executable program instructions embodied therein that when executed by a server perform actions comprising: linking, by a processor, at least a first social media network and a second social media network; receiving, by the processor, a broadcast interaction from a user, wherein the broadcast interaction comprises at least one social media activity; and transmitting, by the processor, a notification of the broadcast interaction to the first social media network and the second social media network.

11. The non-transitory computer-readable storage medium of clause 10, wherein the instructions embodied therein that when executed by the server perform actions comprising:

12. A computer server comprising: a processor; and a non-transitory computer-readable medium storing a computer program executable by the computer processor and performing actions comprising: linking, by an integrated social media platform, a first social media network and a second social media network; receiving, by the integrated social media platform, a broadcast interaction from a user, wherein the broadcast interaction comprises a social media activity; and transmitting, by the integrated social media platform, a notification of the broadcast interaction to the first social media network and the second social media network.

13. The server of clause 12, wherein the plurality of instructions programs the processor to transmit the broadcast interaction to the first social media network and the second social media network.

14. The server of clause 13, wherein the plurality of instructions programs the processor to: generate an integrated social media page, wherein the integrated social media page comprises content from the first social media network and content from the second social media network; and provide the integrated social media page to one or more requestors.

15. The server of clause 14, wherein the plurality of instructions programs the processor to: receive a webcast broadcast interaction comprising a live webcast; notify one or more contacts about the live webcast; display the live webcast on the user's integrated social media page.

16. The server of clause 14, wherein the one or more requestors comprise additional users of the integrated social media platform.

17. The server of clause 14, wherein the one or more requestors comprise non-users of the integrated social media platform.

18. The server of clause 14, wherein the plurality of instructions programs the processor to: receive a chat broadcast interaction from the user, wherein the chat broadcast interaction comprises a request to one or more contacts to initiate a chat session with the user; transmit a chat notification to the one or more contacts; and initiate a chat session between the one or more contacts and the user.

19. The server of clause 18, wherein the chat broadcast interaction comprises a video chat request, and wherein the chat session comprises a video chat session.

20. The server of clause 12, wherein the plurality of instructions programs the processor to: receive an update broadcast interaction comprising an update for the first social media network; transmit the update broadcast interaction to the first social media network; and transmit the notification to one or more contacts regarding the update broadcast interaction, wherein the one or more contacts are associated with the second social media network.

What is claimed is:

1. A computer-implemented method executed by a server, the method comprising:
linking, by a processor, at least a first social media network and a second social media network in an integrated social media platform;
receiving, by the processor, a broadcast interaction from a user, wherein the broadcast interaction comprises an interaction between the user and one or more contacts associated with at least one of the first social media network or the second social media network; and
transmitting, by the processor, a notification of the broadcast interaction to at least one of the first social media network and the second social media network.

2. The computer-implemented method of claim 1, comprising transmitting, by the processor, the broadcast interaction to at least one of the first social media network and the second social media network.

3. The computer-implemented method of claim 1, comprising:
generating, by the processor, an integrated social media identity, wherein the integrated social media identity comprises content from the first social media network and content from the second social media network; and
providing, by the processor, the integrated social media identity to one or more client devices.

4. The computer-implemented method of claim 3, comprising:
receiving, by the processor, a webcast broadcast interaction comprising a live webcast hosted by the user;
notifying, by the processor, one or more contacts about the webcast broadcast interaction; and
embedding, by the processor, the live webcast in the user's integrated social media identity.

5. The computer-implemented method of claim 3, comprising providing, by the processor, the integrated social media identity to one or more client devices comprising additional users of the integrated social media platform.

6. The computer-implemented method of claim 3, comprising providing, by the processor, the integrated social media page to one or more requestors comprising non-users of the integrated social media platform.

7. The computer-implemented method of claim 1, comprising:
receiving, by the processor, a chat broadcast interaction from the user, wherein the chat broadcast interaction comprises a request to one or more contacts to initiate a chat session with the user;
transmitting, by the processor, a chat notification to the one or more contacts; and
initiating, by the processor, a chat session between the one or more contacts and the user.

8. The computer-implemented method of claim 7, comprising:
receiving, by the processor, the chat broadcast interaction comprising a video chat request; and
initiating, by the processor, a video chat session between the one or more contacts and the user.

9. The computer-implemented method of claim 1, comprising:
receiving, by the processor, an update broadcast interaction comprising an update for the first social media network;
transmitting, by the processor, the update broadcast interaction to the first social media network; and
transmitting, by the processor, the notification to one or more contacts regarding the update broadcast interaction, wherein the one or more contacts are associated with the second social media network.

10. A non-transitory computer-readable storage medium having executable program instructions embodied therein that when executed by a server perform actions comprising:
linking, by a processor, at least a first social media network and a second social media network;
receiving, by the processor, a broadcast interaction from a user, wherein the broadcast interaction comprises at least one social media activity; and
transmitting, by the processor, a notification of the broadcast interaction to the first social media network and the second social media network.

11. The non-transitory computer-readable storage medium of claim 10, wherein the instructions embodied therein that when executed by the server perform actions comprising:

12. A computer server comprising:
a processor; and
a non-transitory computer-readable medium storing a computer program executable by the computer processor and performing actions comprising:
linking, by an integrated social media platform, a first social media network and a second social media network;
receiving, by the integrated social media platform, a broadcast interaction from a user, wherein the broadcast interaction comprises a social media activity; and
transmitting, by the integrated social media platform, a notification of the broadcast interaction to the first social media network and the second social media network.

13. The server of claim 12, wherein the plurality of instructions programs the processor to transmit the broadcast interaction to the first social media network and the second social media network.

14. The server of claim 13, wherein the plurality of instructions programs the processor to:
generate an integrated social media page, wherein the integrated social media page comprises content from the first social media network and content from the second social media network; and
provide the integrated social media page to one or more requestors.

15. The server of claim 14, wherein the plurality of instructions programs the processor to:
receive a webcast broadcast interaction comprising a live webcast;
notify one or more contacts about the live webcast;
display the live webcast on the user's integrated social media page.

16. The server of claim 14, wherein the one or more requestors comprise additional users of the integrated social media platform.

17. The server of claim 14, wherein the one or more requestors comprise non-users of the integrated social media platform.

18. The server of claim 14, wherein the plurality of instructions programs the processor to:
receive a chat broadcast interaction from the user, wherein the chat broadcast interaction comprises a request to one or more contacts to initiate a chat session with the user;
transmit a chat notification to the one or more contacts; and
initiate a chat session between the one or more contacts and the user.

19. The server of claim 18, wherein the chat broadcast interaction comprises a video chat request, and wherein the chat session comprises a video chat session.

20. The server of claim 12, wherein the plurality of instructions programs the processor to:
receive an update broadcast interaction comprising an update for the first social media network;
transmit the update broadcast interaction to the first social media network; and
transmit the notification to one or more contacts regarding the update broadcast interaction, wherein the one or more contacts are associated with the second social media network.
